(19) United States
(12) Patent Application Publication
(10) Pub. No.: US 2026/0291886 A1
(43) Pub. Date: Sep. 24, 2026

(54) SYSTEM

(71) Applicant: SoftBank Group Corp., Tokyo (JP)

(72) Inventor: Shiho ONO, Tokyo (JP)

(73) Assignee: SoftBank Group Corp., Tokyo (JP)

(21) Appl. No.: 19/567,061

(22) Filed: Mar. 14, 2026

(30) Foreign Application Priority Data
Mar. 19, 2025 (JP) 2025-045235

(51) Int. Cl. H04L 51/02; G06F 40/20; G06N 3/0464; G06N 3/0475; G06V 10/77; G06V 10/82

(52) U.S. Cl. CPC H04L 51/02; G06F 40/20; G06N 3/0464; G06N 3/0475; G06V 10/7715; G06V 10/82

(57) ABSTRACT

A system includes a processor that is configured to input a prompt to a generative artificial intelligence model in order to instruct the generative artificial intelligence model to generate visual information for generating an image or a video that reproduces a viewpoint of a talent or an influencer, recognize an emotion of a user and adjust content to be generated in accordance with the recognized emotion, and deliver generated content to a terminal of the user.

### CROSS-REFERENCE TO RELATED APPLICATION

This application is based on and claims priority under 35 USC 119 from Japanese Patent Application No. 2025-045235 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional content distribution systems and recommendation systems mainly provide static images, videos, or product suggestions based on general user attributes, simple viewing histories, or coarse-grained preference categories. Such systems do not dynamically adapt generated content to the user's current emotional state, and therefore often fail to provide a deeply immersive experience or a strong sense of connection with a talent, an influencer, or another target entity. In particular, when a user desires to experience daily life, viewpoints, or a perceived “world” of a specific talent or influencer, existing systems generally rely on pre-recorded material that is not tailored to the user's emotional condition, individual purchase history, or detailed interests. As a result, the user may perceive the content as generic or impersonal, and the degree of engagement, satisfaction, and perceived unity with the target remains limited. Furthermore, even when user feedback is collected, conventional systems rarely integrate such feedback into subsequent content generation in a structured, automated manner. Consequently, there is a need for a system that generates content reproducing a viewpoint of a talent or influencer using a generative artificial intelligence model, dynamically adjusts the generated content based on recognized user emotions, provides personalized product recommendations based on user history and interests, and reflects user feedback in subsequent content generation so as to deliver a more valuable and immersive user experience.

### SUMMARY

In order to solve the above-described problems, an embodiment of the present invention provides a system comprising a processor, wherein the processor is configured to input a prompt to a generative artificial intelligence model in order to instruct the generative artificial intelligence model to generate visual information for generating an image or a video that reproduces a viewpoint of a talent or an influencer, recognize an emotion of a user and adjust content to be generated in accordance with the recognized emotion, and deliver generated content to a terminal of the user. According to this configuration, the system can generate images or videos that simulate the first-person viewpoint or subjective perspective of a given talent or influencer, while dynamically adapting the generated content to the user's current emotional state so as to enhance immersion and emotional resonance. In addition, in some embodiments, the processor is configured to analyze a past purchase history and interests of the user and perform a personalized product recommendation so that the user feels a special connection and can be immersed in a world of a target, thereby increasing relevance and perceived value of suggested experiences or products. Furthermore, in some embodiments, the processor is configured to collect feedback from the user and reflect the collected feedback in subsequent content generation so as to provide a valuable experience for the user and deepen a sense of unity with the target over time. Through these combined means, the system can continually refine the generated content and associated recommendations to more closely match individual user preferences, emotions, and feedback, thereby effectively solving the aforementioned problems.

The term “system” refers to a combination of hardware, software, and communication components that cooperate to execute the processing described in the claims, including at least one processor and, in some embodiments, one or more user terminals and storage devices.

The term “processor” refers to any hardware element or combination of hardware elements, such as a central processing unit (CPU), graphics processing unit (GPU), application-specific integrated circuit (ASIC), or programmable logic device, that executes instructions to perform the functions described in the claims.

The term “generative artificial intelligence model” refers to a machine learning model, such as a neural network, that is trained to generate new data, including images or videos, based on input data or instructions, and that is capable of producing visual information used to create content reproducing a viewpoint of a talent or an influencer.

The term “prompt” refers to information, including text, parameters, or other structured or unstructured data, that is input to the generative artificial intelligence model to specify, condition, or constrain the content, style, or characteristics of visual information to be generated.

The term “visual information” refers to data representing visual content, including but not limited to pixel data, feature maps, or intermediate representations, which can be used to form or render images or videos.

The term “image” refers to a still visual representation, such as a photograph, frame, or graphic, generated or processed by the system based on output from the generative artificial intelligence model.

The term “video” refers to a sequence of images or frames displayed over time, optionally accompanied by audio, generated or processed by the system based on output from the generative artificial intelligence model.

The term “viewpoint” refers to a visual perspective or line of sight that defines how a scene is observed, including a first-person or subjectively simulated perspective corresponding to the eyes or point of view of a talent or an influencer.

The term “talent” refers to an individual, such as an entertainer, celebrity, or other public figure, whose viewpoint, lifestyle, or world is to be reproduced or simulated in generated images or videos.

The term “influencer” refers to an individual who exerts influence over an audience, for example through social media or online platforms, and whose viewpoint or activities are used as a basis for generating content.

The term “user” refers to a person who interacts with the system, including viewing generated content, providing feedback, making purchases, or otherwise operating a terminal connected to the system.

The term “emotion” refers to an affective or psychological state of the user, such as happiness, sadness, excitement, or calmness, which is recognized or estimated by the system and used to adjust content generation.

The term “recognize an emotion of a user” refers to detecting, estimating, or classifying the user's emotional state based on input data such as facial expressions, voice, physiological signals, interaction patterns, or explicit user input.

The term “adjust content to be generated” refers to modifying one or more aspects of the content generation process, such as scenario, style, pacing, or intensity, in accordance with the recognized emotion of the user.

The term “generated content” refers to images, videos, or other media that are produced by or with the assistance of the generative artificial intelligence model based on prompts, style information, or other input provided by the processor.

The term “terminal of the user” refers to an electronic device operated by the user, such as a smartphone, tablet, personal computer, headset, or display device, which can receive and present the generated content delivered by the system.

The term “past purchase history” refers to records of products, services, or content previously purchased or accessed by the user through the system or through an associated service.

The term “interests of the user” refers to preferences, likes, or tendencies of the user, which may be inferred from purchase history, viewing behavior, interaction logs, profile information, or explicit user declarations.

The term “personalized product recommendation” refers to a suggestion of one or more products, services, or pieces of content that is generated individually for a specific user based on the user's past purchase history, interests, and other related information.

The term “target” refers to an entity, such as a talent, an influencer, a character, or a thematic world, whose viewpoint, lifestyle, or context is reproduced or simulated in the generated content and with which the user is intended to feel a connection or sense of unity.

The term “feedback from the user” refers to information provided by the user regarding satisfaction, preferences, evaluations, or reactions to generated content or recommendations, including explicit inputs such as ratings and comments, or implicit signals such as viewing duration and interaction patterns.

The term “subsequent content generation” refers to one or more later executions of a content generation process that occur after the collection of feedback from the user and that may be modified or improved based on such feedback.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

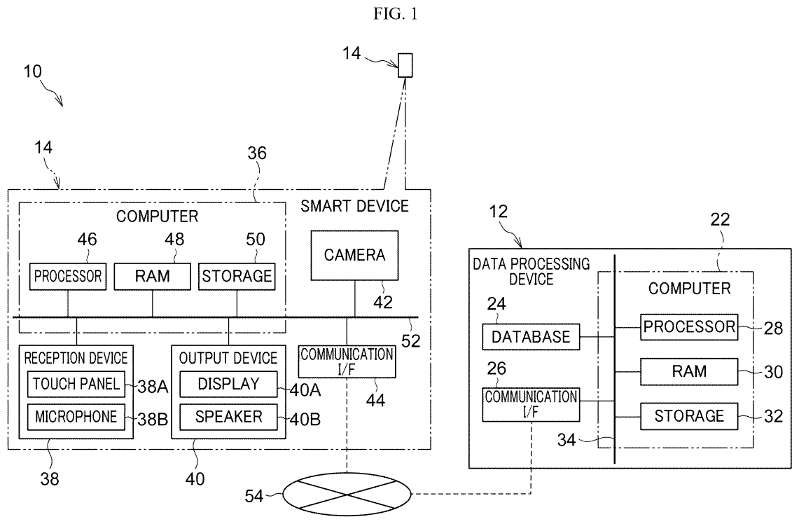

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

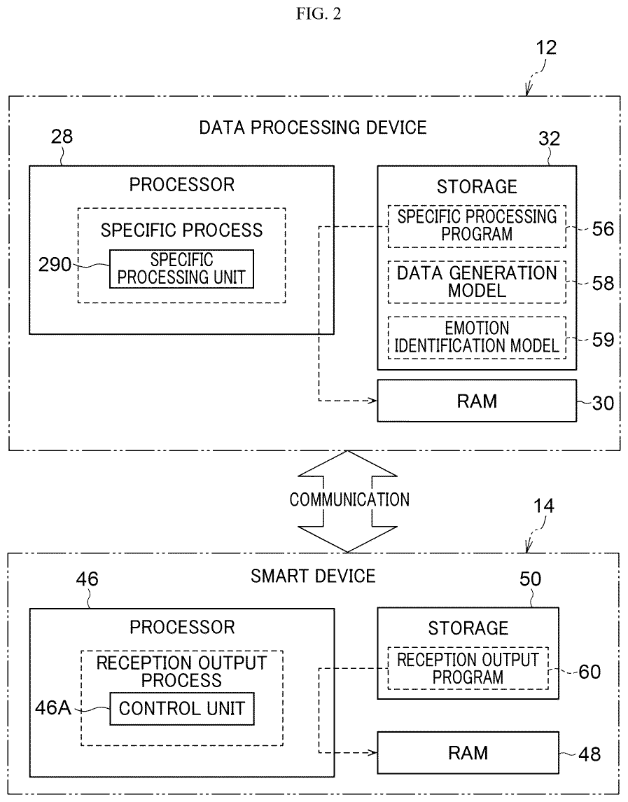

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional content delivery systems that utilize generative AI models primarily rely on static, manually authored prompts and generic user preference data. In such systems, a processor typically receives a simple text instruction and forwards it to a generative AI model without deeply analyzing source data that characterizes a particular viewpoint of an information providing entity, such as a creator or publisher. As a result, the generated images or videos merely approximate a theme or topic and fail to capture consistent positional context, object emphasis, capture conditions, or expression style that are characteristic of that entity. This leads to content that appears superficial, lacks coherence across sessions, and does not provide an immersive sense of “seeing through the eyes” of the information providing entity.

Further, existing systems often treat user behavior history and feedback data as auxiliary marketing information, rather than as signals that can be structurally fed back into the technical pipeline of viewpoint modeling and prompt generation. Because user purchase history, viewing behavior, and feedback are not tightly integrated into the generation of the prompt sentence and the viewpoint profile used by the generative AI model, the system cannot effectively refine or adapt the internal representation of the information providing entity's viewpoint over time. This limits the system's ability to converge toward more accurate and satisfying content generation.

In addition, many known architectures separate upstream content analytics from downstream AI generation, without a unified representation that can technically guide the generative AI model. Text analysis and image or video analysis are often performed in isolation or for reporting purposes only, and their results are not integrated into a machine-readable viewpoint profile used directly to control prompt generation. Consequently, the generative AI model operates with incomplete or loosely connected context, resulting in inefficient use of computational resources and suboptimal output quality.

Moreover, typical recommendation engines in content platforms are implemented as independent modules that operate on high-level metadata and collaborative-filtering signals. Such engines do not exploit the detailed internal viewpoint profile or the prompt generation logic, and thus cannot recommend experience products that are technically matched to both the user's behavior and the fine-grained attributes of the generated content. This disconnect reduces the technical effectiveness of personalization and can increase unnecessary data transfers and processing due to irrelevant or low-quality recommendations.

Accordingly, there is a need for a computer-implemented system that technically improves the generation and delivery of viewpoint-imitating visual content by: (i) automatically constructing and updating a viewpoint profile from heterogeneous source data of an information providing entity using natural language processing and image recognition, (ii) generating a structurally grounded prompt sentence for a generative AI model based on this viewpoint profile and user experience requests, and (iii) feeding back user behavior history and feedback into the viewpoint profile and prompt generation conditions. Such a system should more efficiently utilize computing resources to produce content that is both technically coherent with the modeled viewpoint and better aligned with user expectations, thereby improving the functioning of the content generation and delivery computer system itself.

The specific processing by the specific processing unit 290 of the data processing device 12 in Example 1 is realized by the following means.

The present invention provides a server comprising a processor, the processor being configured to receive, from a user terminal, input information regarding an information providing entity, identify information sources related to the information providing entity based on the input information, and acquire, from the information sources via a communication network, text data and image data or video data regarding the information providing entity; analyze the acquired text data by using natural language processing executed by the processor, and analyze the acquired image data or video data by using image recognition processing executed by the processor, to extract viewpoint feature data including position information, object information, capture condition information, and expression style information that characterize a viewpoint of the information providing entity, and generate viewpoint profile data by integrating the viewpoint feature data in a machine-readable structure; automatically generate, by the processor, a prompt sentence configured to instruct a generative AI model executed on the server or on an external computing resource to generate visual information imitating the viewpoint of the information providing entity, based on the viewpoint profile data and experience request information received from the user terminal; input the prompt sentence into the generative AI model and cause the generative AI model, by numerical computation processing on one or more processors, to generate content data including image data or video data that imitates the viewpoint of the information providing entity; perform, by the processor, format conversion processing or quality adjustment processing on the generated content data and register the processed content data as content data of an experience product in a storage device; receive, from the user terminal, a purchase request for the content data registered as the experience product, and, in response to the purchase request, deliver the content data to the user terminal via the communication network; analyze, by the processor, behavior history data and attribute data of a user in association with the viewpoint profile data and the registered content data to generate product proposal data that selects, for each user, experience products having high relevance; and store, as feedback data, evaluation information or comment information received from the user terminal after viewing of the content data, and update at least one of the viewpoint profile data and generation conditions of the prompt sentence by using the feedback data so that updated conditions are reflected in a subsequent content generation process performed by the generative AI model. This enables the server to technically improve the generation and delivery of viewpoint-imitating visual content by constructing and iteratively refining a unified viewpoint profile that directly governs prompt sentence generation for the generative AI model, thereby allowing the computing system to produce more coherent, contextually accurate, and user-aligned content with improved efficiency and adaptability.

The term “system” refers to an arrangement of one or more computing devices, storage devices, and communication interfaces that cooperate to execute programmed instructions to perform the functions described herein.

The term “processor” refers to a hardware execution unit, such as a central processing unit or graphics processing unit, or a combination thereof, configured to execute machine-readable instructions to perform data processing operations.

The term “user terminal” refers to a computing device operated by a user, such as a smartphone, tablet, personal computer, or head-mounted display, that is capable of transmitting data to and receiving data from the server via a communication network.

The term “information providing entity” refers to a person, group, or organization that publishes or provides content, and whose viewpoint or characteristic style is to be imitated by generated visual content.

The term “information source” refers to an electronic data source associated with an information providing entity, including, for example, a network site, a social networking service account, a blog, or another digital content platform from which text, image, or video data can be acquired.

The term “text data” refers to character-based information, including but not limited to posts, captions, comments, articles, and metadata, obtained in a machine-readable text format from an information source.

The term “image data” refers to still visual data, such as photograph data, illustration data, or frame data, stored in a digital format including, for example, bitmap formats or compressed image formats.

The term “video data” refers to moving image data composed of a sequence of frames, optionally including associated audio data, stored in a digital format such as a container file or streaming format.

The term “natural language processing” refers to a set of computer-implemented techniques for analyzing, interpreting, and transforming human language text, including at least one of tokenization, part-of-speech tagging, named-entity recognition, sentiment analysis, and text embedding generation.

The term “image recognition processing” refers to a set of computer-implemented techniques for analyzing image data or video data, including at least one of object detection, scene classification, feature extraction, and style analysis.

The term “viewpoint feature data” refers to data representing attributes that characterize a viewpoint of an information providing entity, including position information, object information, capture condition information, and expression style information derived from analyzed source data.

The term “position information” refers to data indicating spatial or geographical attributes related to content, including at least one of location identifiers, coordinates, relative positions within a scene, or camera placement characteristics.

The term “object information” refers to data indicating types of objects or subjects that appear or are emphasized in content, including categories such as buildings, natural scenery, people, or artifacts detected in images or text.

The term “capture condition information” refers to data indicating contextual conditions under which visual content is represented, including at least one of time of day, lighting conditions, weather conditions, viewpoint height, or viewing angle.

The term “expression style information” refers to data indicating stylistic or aesthetic characteristics of content, including at least one of color tone, compositional tendency, degree of realism, emotional tone, or narrative style.

The term “viewpoint profile data” refers to an integrated, machine-readable representation of viewpoint feature data, structured to describe characteristic patterns of an information providing entity's viewpoint for use in content generation.

The term “experience request information” refers to information received from a user terminal indicating a user's desired experience, including at least one of a target location, subject, time, mood, or other conditions for content generation.

The term “prompt sentence” refers to a text-based instruction generated by the processor and provided as input to a generative AI model to specify conditions, style, and viewpoint for generating visual content.

The term “generative AI model” refers to a machine learning model configured to generate new data, such as image data or video data, based on input conditions including a prompt sentence, using numerical computation such as neural network inference.

The term “numerical computation processing” refers to operations performed by a processor or accelerator to process numerical data, including matrix operations, tensor computations, and other arithmetic operations used in machine learning inference.

The term “content data” refers to digital media generated by the generative AI model, including at least one of image data and video data, which imitates a viewpoint of an information providing entity.

The term “format conversion processing” refers to processing that changes a data format of content data, including at least one of changing resolution, encoding format, aspect ratio, or container format for distribution.

The term “quality adjustment processing” refers to processing that modifies quality parameters of content data, including at least one of adjusting brightness, contrast, compression level, or noise characteristics.

The term “experience product” refers to a commercially offered digital product composed of content data that is generated to enable a user to experience or re-experience the viewpoint of an information providing entity.

The term “purchase request” refers to a request transmitted from a user terminal to obtain usage rights for an experience product, the request including identification of the product and user-related transaction information.

The term “behavior history data” refers to data representing past actions of a user in the system, including at least one of viewing history, purchase history, interaction logs, or navigation patterns.

The term “attribute data” refers to data describing characteristics of a user, including at least one of demographic information, declared preferences, or device-related attributes.

The term “product proposal data” refers to data indicating recommended experience products selected for a user based on behavior history data, attribute data, and associations with viewpoint profile data and content data.

The term “evaluation information” refers to user-provided metrics or scores indicating a user's assessment of content data, including at least one of ratings, rankings, or like/dislike inputs.

The term “comment information” refers to user-provided natural language text describing impressions, opinions, or feedback regarding content data.

The term “feedback data” refers to data including at least one of evaluation information and comment information, stored for use in updating viewpoint profile data or generation conditions of the prompt sentence.

The term “generation conditions of the prompt sentence” refers to parameters and rules used by the processor to construct the prompt sentence, including weighting of viewpoint features, selection of descriptive phrases, and constraints on style or content.

The term “content generation process” refers to a sequence of operations in which the processor generates a prompt sentence, provides the prompt sentence to a generative AI model, and obtains content data from the generative AI model.

In one embodiment, a server operates as a network-connected content generation and delivery platform. The server includes at least one processor, a main memory, a non-volatile storage device, and a network interface. The server runs an operating system such as a general-purpose server operating system and executes application programs implemented, for example, in a high-level language environment. The server is connected via a communication network to one or more terminals. Each terminal is a computing device such as a smartphone, a tablet, or a personal computer, and includes a display, input interface, local processor, memory, and a network communication module. A user operates the terminal to input requests, view generated content, and provide feedback.

The server uses a combination of software modules to implement the claimed functions. In one example, the server uses a natural language processing library such as spacy or a transformer-based framework such as a text transformer library to analyze text data. The server uses a computer vision framework such as a deep learning library to process image data and video data. The server uses a deep learning inference framework such as a tensor computation library to execute a generative AI model. The generative AI model is, for example, a diffusion-type image generation model or a transformer-based image generation model that accepts a prompt sentence as text input and outputs image data or video frames.

The server stores intermediate and final data in a structured storage system such as a relational database and an object storage service.

The server configures internal data structures for representing information providing entities and their viewpoints. The server creates, in one example, an entity record including fields such as an entity identifier, a list of associated information source identifiers, and metadata.

The server further defines a viewpoint profile structure containing fields for position attributes, object attributes, capture condition attributes, and expression style attributes. Each attribute is represented by numerical feature vectors and discrete labels. The server maintains a feature table for text data and a feature table for image and video data. Each record in a feature table includes an entity identifier, a source identifier, a feature vector, and auxiliary metadata such as timestamps and content type.

The server uses specific algorithms for extracting viewpoint feature data. For text data, the server applies a transformer-based language model to obtain embeddings for sentences or paragraphs. The server then applies clustering and frequency analysis over these embeddings and over named-entity recognition results to determine frequently occurring locations (for example, place names), frequently mentioned objects (for example, buildings, landscapes), and characteristic expressions (for example, emotional descriptors, stylistic phrases). The server normalizes these results into position information, object information, capture condition information, and expression style information. For example, the server transforms repeated mentions of “at sunset near the tower” and “evening sky behind the tower” into a capture condition attribute indicating a favored time-of-day of “sunset” and a position attribute indicating a vantage point with a specific relative angle to the tower.

For image data and video data, the server uses a convolutional or transformer-based vision model to extract feature vectors from each image or video frame. The server performs object detection and scene classification to identify objects such as buildings, streets, and natural elements and scenes such as city night scenes or coastal sunsets. The server further computes color histograms or uses a style classification network to detect dominant color palettes and artistic style tendencies, such as warm tones, high contrast, or cinematic framing. The server also infers capture conditions such as time of day and lighting conditions based on color distribution and brightness. The server aggregates these numerical features over multiple pieces of content associated with a single information providing entity to obtain stable estimates of viewpoint features.

The server integrates text-derived features and visual-derived features into viewpoint profile data. The server uses a numerical optimization or weighting scheme to combine heterogeneous features. For example, the server maps both text embeddings and image embeddings into a shared embedding space using a joint embedding model or a linear transformation, and then computes weighted averages or cluster centroids representing central tendencies for each attribute category. The server stores the resulting viewpoint profile data as a structured record that can be quickly accessed and updated. Because the server uses compact vector representations and precomputed aggregates, the server can generate prompt sentences and derive new content conditions with low latency even when source data is large.

The server then uses the viewpoint profile data to construct prompt sentences for a generative AI model. The server includes a prompt generation module that selects descriptive phrases, attribute terms, and structural patterns based on the viewpoint profile. The server uses a ruleset or template set, where each template specifies a natural language structure for a prompt sentence. The server selects a template and fills it with attributes from the viewpoint profile and user-specified conditions. For example, when a user requests an experience related to a tower in a city, the server selects attributes such as preferred time of day, emotional tone, and perspective from the viewpoint profile of the corresponding information providing entity and inserts them into a template.

In one example, the server generates a prompt sentence such as:

“From the viewpoint of travel information provider B, generate the scenery of the Eiffel Tower in Paris at sunset, with a romantic atmosphere, warm color tones, and a first-person perspective as if seen through the provider's eyes.”

In another example, the server generates a prompt sentence such as:

“From the viewpoint of information provider A, generate a realistic night scene of New York streets with bright neon signs, wet asphalt reflecting lights, and surrounding skyscrapers, in a cinematic first-person perspective.”

In a further example, the server generates a prompt sentence such as:

“From the viewpoint of sports information provider C during a soccer match, generate an image of the stadium as seen from the field, with vivid crowd details and dynamic motion blur around the players.”

The server provides these prompt sentences as input to a generative AI model. In one embodiment, the generative AI model is a diffusion-type generative model, which includes a text encoder, a denoising network, and a decoder. The text encoder converts the prompt sentence into a sequence of token embeddings, which are then aggregated into a condition vector. The denoising network is a neural network, such as a U-Net architecture or a transformer-based architecture, that iteratively refines a noise sample toward an image sample conditioned on the text embedding. The decoder converts the latent representation into final image pixels. The server runs this generative AI model using a hardware accelerator, such as a graphics processing unit, and uses numerical libraries optimized for parallel tensor operations. The server can adjust model parameters such as the number of diffusion steps, sampling schedule, and guidance scale to balance quality and computation time.

In another embodiment, the generative AI model is configured to generate short video sequences instead of single images. In such a case, the model includes a temporal extension of the architecture, such as a 3D convolutional network or a temporal transformer, to maintain coherence across frames. The server conditions this model on the same prompt sentence and, optionally, on additional motion descriptors derived from the viewpoint profile, such as typical camera movements or panning directions.

The server improves computer technology by integrating viewpoint profile data directly into the prompt generation process in a non-conventional manner. Conventional systems might store user or entity preferences as simple tags or text labels. In contrast, the server constructs multi-dimensional viewpoint feature vectors that are specifically designed to align with the conditioning interface of the generative AI model. By doing so, the server reduces trial-and-error prompt design and minimizes repeated calls to the generative AI model that would otherwise be required to manually refine content. This reduction in redundant model invocations reduces computation load on the generative AI model, decreases overall processing time, and reduces network traffic when the model is accessed via a remote API.

The server also implements a feedback mechanism that goes beyond mere logging of user actions. The server collects behavior history data, including which content was requested, how long it was viewed, and which experience products were purchased. The server also collects explicit feedback data, such as ratings and text comments. The server encodes this feedback data into numerical signals that adjust weights within the viewpoint profile. For example, when content generated with certain style attributes receives consistently higher evaluations, the server increases the weight of those style attributes in the viewpoint profile.

When feedback indicates dissatisfaction with certain attributes, the server reduces their weight or removes them from future prompt sentences.

The server uses these feedback signals in a machine learning loop that updates model parameters used for prompt construction. In one example, the server uses a reinforcement learning or bandit-style algorithm that selects among alternative prompt templates or attribute combinations and measures user responses as rewards. The server adjusts the selection probabilities to favor configurations that yield higher user satisfaction. This process modifies the internal rules used for prompt construction, thereby technically improving the effectiveness of prompt usage in the generative AI model interface.

The server manages data structures and algorithms to improve computation efficiency and memory usage. The server stores viewpoint profile data as compressed vectors in a vector database or efficient array structure. When a user request arrives, the server only needs to fetch a small number of vector records and perform lightweight operations to build a prompt sentence, rather than scanning all historical content. This design reduces memory footprint and speeds up query processing. The server also caches frequently used viewpoint profiles and prompt templates in a high-speed cache, reducing storage access latency.

The server further implements content optimization mechanisms for delivery. After the generative AI model outputs image data or video data, the server performs specific format conversion and quality adjustment operations. The server may, for example, use an image processing library or a video encoding tool to re-encode images and video into formats suitable for streaming or download over a constrained network, reducing file sizes while maintaining perceived quality. By choosing encoding parameters adapted to the terminal type and network condition, the server reduces communication load and improves playback stability. In this way, the server leverages the generated content in a technically efficient distribution pipeline that adapts to hardware and network constraints.

The terminal participates in the overall system by providing user interaction and local processing. The terminal displays graphical interfaces through which a user can select information providing entities, specify desired locations or scenarios, and review product recommendations generated by the server. The terminal sends structured requests to the server and receives metadata and content data. The terminal decodes streaming content or downloaded files and renders images or plays videos via a media playback module. The terminal can also locally store a portion of the content data for offline viewing, subject to rights management policies enforced by the server.

The user interacts with the system through the terminal by selecting recommended experience products, initiating purchases, and providing feedback. The user may, for example, select a recommended item labeled as “Eiffel Tower Sunset from Provider B's Viewpoint,” view a preview image, and then confirm purchase. After viewing the content, the user can enter a rating and a short comment, which the terminal transmits to the server as feedback data. This participation is essential for refining the viewpoint profile and improving subsequent content generation.

In another embodiment, the server supports multiple alternative generative AI models. The server maintains a registry of models with different capabilities, such as a high-resolution model, a low-latency model, and a video-focused model. The server selects an appropriate generative AI model based on factors such as the requested output type, the available computation resources, and the network latency constraints. The server can then pass the same or slightly adapted prompt sentence to the selected model. This dynamic model selection allows the server to balance quality and performance in a more granular manner than conventional fixed-pipeline systems.

In a further embodiment, the server uses data augmentation techniques when training or updating models related to viewpoint profile construction or prompt generation. The server may artificially augment text data by paraphrasing sentences, performing synonym replacement, or reordering phrases while preserving semantic content. The server may augment image data by applying transformations such as cropping, rotation, or color jittering.

These augmented data increase the robustness of the feature extraction algorithms and reduce overfitting, thereby improving accuracy of viewpoint characterization even when the amount of original data is limited.

The server can additionally implement a specialized loss function when fine-tuning internal models or auxiliary networks involved in viewpoint profiling. For example, the server may train a model that predicts user satisfaction scores from content features and feedback history.

The server may design a loss function that penalizes both prediction error and deviation from known viewpoint attributes, thus ensuring that the learned model remains faithful to the information providing entity's style while optimizing for user satisfaction. The server updates model parameters using gradient-based optimization methods, such as stochastic gradient descent or adaptive optimization, executed on the server's processor or accelerator.

By structuring data into viewpoint profile vectors aligned with the conditioning mechanism of a generative AI model, by implementing non-trivial prompt generation rules that exploit these vectors, and by integrating user feedback into an iterative refinement loop, the server does more than merely automate human content selection or description. The server modifies how the computing system encodes, conditions, and generates visual content, improving the internal efficiency of the system and the quality of outputs in a way that is specific to the architecture and algorithms employed. This technical configuration reduces wasted computation, reduces communication overhead, and increases the precision with which visual content aligns with modeled viewpoints, thereby improving the functioning of the computer system as a whole.

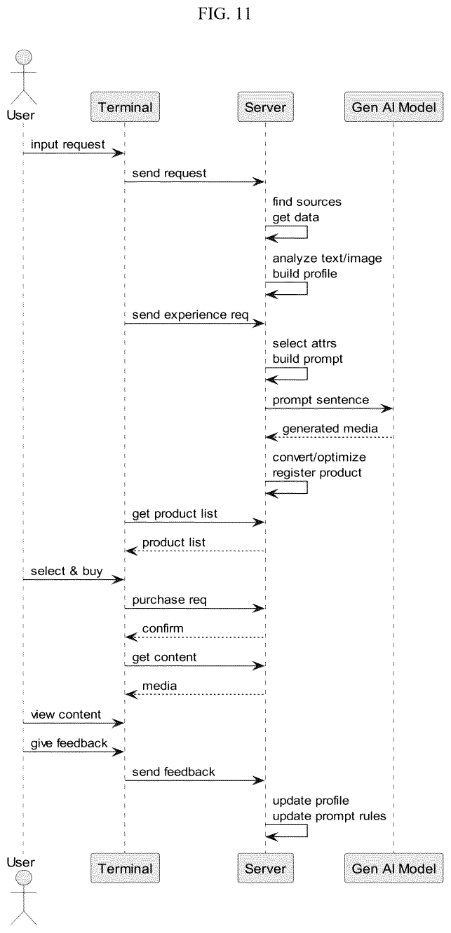

The following describes the processing flow using FIG. 11.

### Step 1

The user operates the terminal to specify an information providing entity and a desired experience. The terminal displays an input screen and accepts text input such as a name, keywords, and optional conditions (for example, location, time of day, mood). The terminal sends a structured request to the server via a network.

Input: user-entered text (entity name, keywords, conditions).

Output: a request message transmitted from the terminal to the server.

### Step 2

The server receives the request message and parses the input fields. The server normalizes the text (for example, lowercasing, trimming spaces) and extracts tokens that are used to search for information sources. The server accesses internal mappings and external search interfaces to identify relevant sources.

Input: request message from the terminal.

Output: a list of candidate information sources (for example, URLs, account identifiers, channel identifiers) associated with the information providing entity.

### Step 3

The server filters the candidate information sources to remove low-relevance entries. The server compares extracted tokens with metadata of each source, such as profile descriptions and tags, and calculates similarity scores. The server discards sources with scores below a threshold and retains high-scoring sources.

Input: list of candidate information sources and metadata.

Output: a refined list of information sources used for data acquisition.

### Step 4

The server acquires text data and image or video data from the refined list of information sources. The server issues network requests (for example, HTTP GET or API calls) to fetch posts, captions, articles, images, and videos. The server converts responses into internal formats and stores text in a database and media files in object storage.

Input: refined list of information sources.

Output: a collection of raw text records and associated media files linked to the information providing entity.

### Step 5

The server preprocesses the collected text data. The server removes markup, URLs, and non-essential symbols, segments text into sentences, and performs tokenization. The server then applies natural language processing models to extract named entities (such as locations and objects), sentiment, and stylistic cues.

Input: raw text records.

Output: cleaned text segments and initial text analysis results (entities, sentiment tags, stylistic descriptors).

### Step 6

The server generates text feature vectors from the cleaned text segments. The server encodes each segment using a transformer-based language model to obtain embeddings. The server aggregates these embeddings per information providing entity by computing statistics such as means and frequency-weighted averages, grouped by detected attributes.

Input: cleaned text segments and text analysis results.

Output: text feature vectors representing locations, objects, capture conditions, and expression style patterns.

### Step 7

The server preprocesses the collected image and video data. The server decodes media files into image frames or thumbnails as needed, resizes them to a fixed resolution, and normalizes pixel values. The server passes each frame through a vision model to obtain object labels, scene labels, and style-related descriptors.

Input: raw image files and video frames.

Output: annotated visual items with object labels, scene labels, and initial visual style information.

### Step 8

The server computes visual feature vectors for each annotated visual item. The server uses a feature extraction network to generate vector representations and aggregates these vectors per information providing entity. The server calculates statistics such as dominant objects, typical scenes, and color distributions.

Input: annotated visual items.

Output: visual feature vectors representing object information, scene types, capture conditions, and expression style traits.

### Step 9

The server integrates text feature vectors and visual feature vectors into unified viewpoint feature data. The server aligns feature spaces (for example, by linear transformation) and combines attributes according to predefined rules and weights. The server resolves conflicts and fills missing attributes by favoring sources with higher confidence scores.

Input: text feature vectors and visual feature vectors.

Output: viewpoint feature data that includes position information, object information, capture condition information, and expression style information.

### Step 10

The server generates viewpoint profile data from the viewpoint feature data. The server structures the data into a profile record with fields for preferred locations, frequently depicted objects, common capture conditions, and stylistic descriptors. The server stores the profile record in a database for later use and marks it with a version or timestamp.

Input: viewpoint feature data.

Output: persistent viewpoint profile data associated with the information providing entity.

### Step 11

The server receives a specific experience request from the terminal. The user operates the terminal to select, for example, a target location or type of scene (such as “tower at sunset” or “city at night”) related to the information providing entity. The terminal transmits this detailed request to the server.

Input: detailed experience request from the terminal.

Output: a refined request message that includes entity identifier and requested conditions.

### Step 12

The server interprets the refined request message in the context of the viewpoint profile data. The server matches requested conditions with attributes in the profile (such as matching requested location with preferred locations, and requested mood with expression style). The server selects and weights relevant attributes to be used for prompt construction.

Input: refined request message and viewpoint profile data.

Output: a selected set of viewpoint attributes aligned with the user's requested experience.

### Step 13

The server constructs a prompt sentence for the generative AI model. The server selects a template that best fits the requested content type (for example, static image or short video) and fills template slots with the selected viewpoint attributes and request conditions. The server concatenates descriptive phrases, ensuring grammatical correctness and clear instructions.

Input: selected viewpoint attributes and template definitions.

Output: a text-form prompt sentence specifying viewpoint, style, and content for the generative AI model.

### Step 14

The server optionally generates multiple variant prompt sentences. The server applies controlled variations such as different wording, emphasis on alternative attributes, or changes in detail level, in order to obtain diverse outputs. The server records each variant and its relation to the original request.

Input: base prompt sentence and viewpoint attributes.

Output: a set of prompt sentence variants prepared for content generation.

### Step 15

The server submits one or more prompt sentences to the generative AI model. The server prepares a request containing the prompt sentence, desired resolution, number of outputs, and any guidance parameters. The server sends the request to a local or remote generative AI engine and initiates numerical inference operations.

Input: prompt sentence(s) and generation parameters.

Output: execution of the generative AI model leading to intermediate latent representations and eventual media outputs.

### Step 16

The server receives generated content data from the generative AI model. The server obtains image data or sequences of frames generated according to the prompt sentence. The server associates each generated item with metadata such as prompt identifier, entity identifier, and generation parameters.

Input: generative AI model output.

Output: raw generated media items with associated metadata.

### Step 17

The server performs format conversion processing on the generated content data. The server, for example, converts image files to standard formats and encodes video sequences into streamable formats. The server may resize outputs to resolutions suitable for terminals and attach thumbnails.

Input: raw generated media items.

Output: encoded media files in delivery-ready formats.

### Step 18

The server applies quality adjustment processing to the encoded media files. The server adjusts properties such as brightness, contrast, and compression level, and may apply slight sharpening or noise reduction. The server evaluates file sizes and, if necessary, re-encodes media to meet bandwidth or storage constraints.

Input: encoded media files.

Output: optimized media files that balance quality and resource usage.

### Step 19

The server registers optimized media files as experience products. The server creates catalog entries that include title, description, price, tags, links to the viewpoint profile, and references to the prompt sentence used. The server stores these entries in a catalog database accessible by the terminal.

Input: optimized media files and metadata.

Output: registered experience product records available for browsing and purchase.

### Step 20

The terminal requests a list of experience products related to a particular information providing entity. The server retrieves matching catalog entries and returns product listing data, including titles, thumbnails, and brief descriptions. The terminal displays this list to the user for selection.

Input: product list request from the terminal.

Output: product listing data delivered to the terminal.

### Step 21

The user selects a desired experience product from the product list and initiates a purchase. The terminal collects purchase details and, if necessary, invokes a payment interface. The terminal sends a purchase request to the server including user identification and product identification.

Input: user selection and purchase details.

Output: purchase request message transmitted to the server.

### Step 22

The server processes the purchase request. The server verifies the user's eligibility and payment information via a payment service and, upon success, records the transaction in a purchase history table. The server grants access rights to the corresponding experience product for the user.

Input: purchase request message and payment confirmation.

Output: updated access rights and a confirmation response to the terminal.

### Step 23

The terminal receives the confirmation response and requests delivery of the purchased content. The server identifies the media files associated with the purchased product and initiates content delivery. The server may choose a streaming or download mode based on product type and terminal capabilities.

Input: content delivery request from the terminal and access rights data.

Output: a content delivery session between the server and the terminal.

### Step 24

The terminal receives the media stream or downloaded files and renders the content to the user. The terminal decodes image or video data and displays the generated viewpoint-imitating visuals. The user views the content and experiences the viewpoint of the information providing entity.

Input: delivered media data from the server.

Output: rendered images or videos displayed on the terminal.

### Step 25

The user provides feedback after viewing the content. The terminal captures ratings and text comments entered by the user and sends them to the server as feedback data.

Input: user-entered ratings and comments.

Output: feedback message transmitted to the server.

### Step 26

The server stores the feedback data and updates behavior history and feedback tables. The server links feedback to the corresponding experience product, viewpoint profile, and prompt sentence. The server then analyzes the feedback to determine which viewpoint attributes and prompt patterns correlate with higher user satisfaction.

Input: feedback message and existing profile and product records.

Output: updated feedback records and computed feedback statistics.

### Step 27

The server adjusts viewpoint profile data based on feedback statistics. The server modifies weights of attributes within the profile to increase emphasis on positively evaluated traits and decrease emphasis on negatively evaluated traits. The server may also adjust template selection probabilities for prompt construction.

Input: viewpoint profile data and feedback statistics.

Output: updated viewpoint profile data and updated prompt generation parameters.

### Step 28

The server uses updated viewpoint profile data and prompt generation parameters for subsequent requests. When new experience requests are received, the server applies the updated profiles and parameters, leading to improved alignment between generated content and user preferences.

Input: new experience requests, updated profiles and parameters.

Output: refined prompt sentences and generated content reflecting prior feedback.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content distribution systems and media recommendation engines primarily retrieve and transmit pre-produced images or videos selected from a static catalog. Such systems do not dynamically generate first-person viewpoint content tailored to a particular subject, nor do they adapt underlying generative processing parameters based on rich contextual data and real-time user feedback. As a result, existing systems provide limited immersiveness and personalization, and their technical architectures are not optimized for tightly coupling context acquisition, prompt generation for a generative AI model, and adaptive streaming delivery in a unified pipeline.

In addition, known generative AI integrations typically treat prompt sentences and inference parameters as static or manually crafted inputs. These approaches do not systematically transform large-scale, heterogeneous information sources about a subject into structured context data, and do not automatically refine prompt sentences and generative model parameters based on user emotional state, preferences, or evaluation signals. This leads to inefficient use of computational resources, reduced relevance of generated content, and an inability to iteratively improve content generation quality over time in a machine-driven manner.

Furthermore, conventional streaming architectures are designed to deliver existing media files and are not configured to efficiently handle dynamically generated, user-specific, first-person viewpoint content. Such architectures do not integrate end-to-end processing that starts from subject-related information sources, proceeds through context-aware prompt construction and generative AI inference, and ends with adaptive bitrate streaming optimized per user session. Consequently, they fail to provide a technically improved pipeline that coordinates data collection, model configuration, content encoding, and network distribution as a single optimized process.

Accordingly, there is a need for a computer-implemented system that improves the technical functioning of content generation and delivery pipelines by (i) automatically collecting and structuring subject-related data from distributed information sources, (ii) algorithmically generating and updating prompt sentences and generative AI model parameters to produce first-person viewpoint content, and (iii) integrating the resulting content with adaptive streaming mechanisms and feedback-driven refinement. The technical problem to be solved is to provide an improved server-side processing architecture and associated methods that more efficiently generate, adapt, and deliver personalized viewpoint content, thereby enhancing system-level performance, resource utilization, and user-perceived quality in a manner that goes beyond mere content selection or presentation.

The specific processing by the specific processing unit 290 of the data processing device 12 in Application Example 1 is realized by the following means.

The present invention provides a server comprising a processor configured to acquire, from a user terminal, identification information of a target viewpoint subject and information source identification information, collect over a network text data, image data, and video data related to the target viewpoint subject from one or more information sources, perform natural language processing on the collected data to structure the collected data, and store the structured data as viewpoint-reproduction context data; generate, on the basis of the viewpoint-reproduction context data and experience request conditions acquired from a user, a prompt sentence that instructs a generative AI model to generate visual information representing imagery from a viewpoint of the target viewpoint subject, input the prompt sentence into the generative AI model, and thereby cause the generative AI model to generate image data or video data viewed from the viewpoint of the target viewpoint subject; set, according to the experience request conditions and the viewpoint-reproduction context data, a model type, a resolution, a frame rate, and inference parameters used in inference processing of the generative AI model, perform image quality correction processing and encoding processing on the generated image data or video data, and generate content data for streaming distribution; divide the content data for streaming distribution into segment data and manifest data, generate streams of a plurality of bitrates, notify the user terminal of playback information indicating a location of the manifest data, and sequentially distribute the segment data to the user terminal; and update, on the basis of emotion state information, preference information, or evaluation information acquired from the user terminal, configuration rules of the prompt sentence and the inference parameters of the generative AI model, and adjust contents of viewpoint content from the viewpoint of the target viewpoint subject to be generated subsequently. This enables an integrated, computer-implemented pipeline in which the server automatically transforms heterogeneous subject-related data into structured context, generates and refines prompt sentences and generative AI model parameters in a feedback-aware manner, and produces and delivers adaptive streaming content with improved technical efficiency, scalability, and personalization compared to conventional content generation and distribution systems.

The term “system” refers to a combination of one or more computing devices, storage devices, communication interfaces, and software components that cooperate to execute the functions described in the claims.

The term “processor” refers to one or more processing units, such as a central processing unit, a graphics processing unit, or a specialized accelerator, that execute instructions to perform data processing operations defined by one or more programs.

The term “user terminal” refers to an electronic device operated by a user, such as a smartphone, tablet, desktop computer, notebook computer, or head-mounted display device, that communicates with the server and presents content to the user.

The term “target viewpoint subject” refers to a real or fictitious entity, such as a person, character, or avatar, whose visual perspective is to be reproduced in generated image data or video data.

The term “information source” refers to any data provider accessible over a communication network, including a web service, content server, social networking service, blog service, or database, from which subject-related text data, image data, or video data can be obtained.

The term “identification information” refers to data that uniquely or quasi-uniquely specifies an entity, such as a subject identifier, account identifier, content identifier, or resource locator.

The term “information source identification information” refers to data that specifies one or more information sources, such as a uniform resource locator, an application programming interface endpoint, or an account identifier associated with the information source.

The term “text data” refers to character-based information, such as posts, captions, comments, tags, or descriptions, that can be processed by natural language processing techniques.

The term “image data” refers to still visual information represented in a digital format, such as bitmap data, raster data, or compressed still image files.

The term “video data” refers to time-sequential visual information represented in a digital format, including one or more encoded video streams and optionally associated audio streams.

The term “natural language processing” refers to a set of computational techniques for analyzing and transforming human language text, including tokenization, normalization, language detection, entity extraction, and other linguistic analyses.

The term “structured data” refers to data that has been organized according to a defined schema or format, such as records, fields, or key-value pairs, to facilitate subsequent retrieval and processing.

The term “viewpoint-reproduction context data” refers to structured data derived from subject-related information sources that describe circumstances, locations, times, events, and other contextual elements used to generate content from a viewpoint of the target viewpoint subject.

The term “experience request conditions” refers to information received from the user or user terminal that specifies desired attributes of generated content, such as scenario type, location, time, mood, style, duration, resolution, or other content-generation parameters.

The term “prompt sentence” refers to a machine-readable natural language instruction or description that is supplied as input to a generative AI model to specify the characteristics of visual content to be generated.

The term “generative AI model” refers to a machine-learned model that, in response to an input including a prompt sentence, automatically produces new data such as image data or video data that was not explicitly present in the training data.

The term “visual information” refers to information representing visual content, including but not limited to rendered images, image frames, and video sequences.

The term “image data or video data viewed from the viewpoint of the target viewpoint subject” refers to generated visual content that is composed such that the camera position, orientation, and framing simulate a first-person or subjective perspective of the target viewpoint subject.

The term “model type” refers to a classification of a generative AI model, such as an image generation model, a video generation model, or a style-specific model, selected according to the content generation requirements.

The term “resolution” refers to a spatial size of generated visual content, typically expressed in pixels along horizontal and vertical dimensions.

The term “frame rate” refers to a temporal sampling rate of video content, typically expressed as a number of frames presented per second.

The term “inference parameters” refers to configurable values used during execution of a generative AI model, such as a number of inference steps, sampling parameters, guidance scales, temperature values, or noise levels.

The term “image quality correction processing” refers to post-processing applied to generated visual content, such as upscaling, denoising, color correction, contrast adjustment, sharpening, or artifact reduction.

The term “encoding processing” refers to compression and formatting of visual content into a digital representation suitable for storage or transmission, such as encoding using a video codec or image codec.

The term “content data for streaming distribution” refers to encoded media data prepared for delivery over a network in a streaming format, including video, audio, and associated control or metadata information.

The term “segment data” refers to temporal subdivisions of the content data for streaming distribution, each segment representing a portion of the media timeline, suitable for sequential or adaptive retrieval by a client.

The term “manifest data” refers to control information describing how segment data is organized and accessed, including a list of segment locations, timing information, and available bitrate variants.

The term “streams of a plurality of bitrates” refers to multiple encoded versions of the same content data, each having a different data rate, resolution, or quality level to enable adaptive streaming according to network conditions or device capabilities.

The term “playback information” refers to data indicating at least a location or identifier of manifest data and optionally additional parameters required for a user terminal to request and play back streaming content.

The term “emotion state information” refers to data indicative of a user's emotional condition, inferred or measured by the user terminal or another component, such as labels representing mood, arousal, or valence.

The term “preference information” refers to data that expresses a user's likes, dislikes, or configuration choices regarding content attributes, such as style, pacing, viewpoint intensity, or thematic focus.

The term “evaluation information” refers to feedback data provided by the user or automatically computed, including ratings, textual feedback, interaction metrics, or quality assessments related to generated content.

The term “configuration rules of the prompt sentence” refers to rules or parameters that govern how prompt sentences are assembled, expanded, weighted, or otherwise constructed from context data and user-related information.

The term “contents of viewpoint content” refers to semantic and structural elements of generated first-person viewpoint media, including scenes, objects, actions, and presentation style included in the output of the generative AI model.

The term “visual presentation device” refers to a hardware component or assembly capable of displaying visual content to a user, such as a display panel of a smartphone, a monitor, a projector, or a head-mounted display.

The term “candidate re-experience products” refers to items or offerings selected as suitable for association with a particular generated experience, such as digital experiences, physical goods, or service offerings related to the target viewpoint subject.

The term “scenes, situations, or objects corresponding to the candidate re-experience products” refers to visual elements included in generated content that depict or reference environments, events, or items associated with the candidate re-experience products.

The term “improvement request information” refers to user-supplied data indicating desired changes to generated content, such as requests for different pacing, atmosphere, detail level, or viewpoint characteristics.

The term “preference change information” refers to data indicating that a user's preferences have evolved or shifted, as reflected in updated user settings, interaction patterns, or explicit declarations.

The term “viewpoint expressions” refers to words, phrases, or prompt components that specify perspective-related characteristics, such as first-person framing, field of view, camera angle, or extent of body parts visible in the scene.

The term “scene expressions” refers to words, phrases, or prompt components that describe locations, backgrounds, environmental conditions, or events to be depicted in generated content.

The term “emotion expressions” refers to words, phrases, or prompt components that describe or imply emotional tone, mood, or affect to be conveyed by generated content.

The term “negative prompt elements” refers to components of a prompt or control input that specify undesired attributes or artifacts to be suppressed during content generation, such as indicating objects, styles, or distortions that should not appear.

In one embodiment, a server, a terminal, and a user cooperate to implement the claimed system. The server executes software modules on hardware that may include a multi-core central processing unit (CPU), a graphics processing unit (GPU), a main memory, a non-volatile storage device, and a network interface. For example, the server uses a general-purpose CPU such as an x86-64 processor, a GPU such as a programmable graphics accelerator, an operating system such as a server-class operating system, and a runtime environment such as a Python execution environment and a deep learning framework such as a tensor computation library. The terminal uses a processor, a display device, an input interface, and a network interface, and may be realized by a smartphone, a tablet, a personal computer, or a head-mounted display.

The server executes a plurality of software components including a data collection module, a natural language processing module, a context structuring module, a prompt generation module, a generative AI model inference module, an image and video post-processing module, an encoding and streaming module, and a feedback analysis module. Each module operates on explicitly defined data structures, and the modules are connected via well-defined data flows in memory and storage.

The server acquires, from the terminal, identification information of a target viewpoint subject and information source identification information. The terminal presents a graphical user interface that lists subjects such as a “performer A,” “influencer B,” or “character C” in abstract form. The user selects one subject and a desired re-experience scenario, such as “urban evening walk,” “backstage before a performance,” or “morning routine at home.” The terminal sends a request message to the server via a network using a protocol such as HTTPS.

The request message contains a subject identifier, one or more information source identifiers such as API endpoints or resource locators, and experience request conditions such as desired location, time of day, mood, duration, and resolution.

The server uses the data collection module to retrieve subject-related data from information sources. The server sends HTTP requests to web service APIs, such as generic blog APIs or social networking APIs, to obtain text posts, captions, tags, image files, and video files associated with the subject identifier. The server stores the raw data in a storage subsystem, for example a relational database or a document-oriented database, using a schema including fields for subject identifier, timestamp, location tags, topic tags, and media references.

The server uses the natural language processing module to transform raw text data into normalized and structured form. The server employs tokenization, language identification, part-of-speech tagging, and named entity recognition using a language processing library such as a statistical or neural NLP toolkit. The server extracts entities such as geographic locations, event types, time expressions, and sentiment indicators. The server represents the results as a structured context record, for example a JSON-like object containing fields for location, time, event label, sentiment score, and keywords.

The server uses the context structuring module to combine multiple context records into viewpoint-reproduction context data for each scenario type. The server generates a context graph in memory, where nodes represent events or scenes associated with the subject and edges represent temporal or thematic relationships. This context graph is stored as viewpoint-reproduction context data in the database. The structuring of data in this way allows efficient retrieval and combination of relevant scenes for prompt generation and model conditioning, thus improving retrieval latency and generation consistency compared to simple flat text aggregation.

The server uses the prompt generation module to construct a prompt sentence for a generative AI model. The server receives experience request conditions from the terminal, such as “subject: performer A, location: European city, time: sunset, mood: relaxed, duration: 30 seconds.” The server searches the viewpoint-reproduction context data for records whose location and time attributes match the requested conditions. From these records, the server extracts representative phrases and descriptive attributes such as “cobblestone streets,” “riverbank,” “warm street lights,” or “crowd noise.” The server then applies a deterministic rule engine in combination with a language model to assemble a prompt sentence that includes: (i) a first-person perspective instruction, (ii) scene descriptions consistent with the context graph, and (iii) any user-specified mood or style.

For example, the server generates a prompt sentence such as:

“Generate a first-person POV video from the perspective of performer A during an evening walk along a river in a European city, with warm street lights reflecting on the water, the performer's hands occasionally visible holding a cup, and realistic ambient city sounds, cinematic style, smooth motion, high resolution.”

In another example, the server generates:

“Generate a first-person POV video from the perspective of an influencer preparing backstage before a live performance, showing staff members, instruments, and the entrance curtain, with realistic stage lighting and muffled crowd noise in the distance, immersive and natural movement.”

The use of structured context data rather than static, hand-crafted prompts allows the server to generate prompt sentences that more precisely encode scene constraints and perspective information, which reduces ambiguity for the generative AI model and improves both the relevance and consistency of generated content.

The server uses the generative AI model inference module to execute a generative AI model.

In one embodiment, the generative AI model is a diffusion-based neural network trained to map from text embeddings to images or videos. The neural network includes a text encoder, such as a transformer-based encoder that maps the prompt sentence into a fixed-length embedding vector, and a U-Net-like convolutional backbone that performs iterative denoising in a latent space. For video, the network extends the spatial convolution operations to three-dimensional convolutions or recurrent structures to handle temporal dimensions.

The server loads the neural network parameters into GPU memory. The server sets inference parameters, including the number of diffusion steps, guidance scale for classifier-free guidance, sampling schedule, frame count, resolution, and frame rate, based on the experience request conditions and system constraints. The server then executes the forward computation of the model, repeatedly applying the U-Net backbone to noise-perturbed latent tensors while conditioning on the text embeddings of the prompt sentence. This process numerically integrates a denoising trajectory in latent space, producing latent representations for each frame, which are finally decoded via a decoder network into pixel-space images.

The server performs post-processing on the generated images or frames using an image and video post-processing module. The server may apply super-resolution via another trained neural network, such as a generative adversarial upscaler, color correction based on histogram analysis, and temporal smoothing via optical flow-based interpolation. These processing steps reduce visual artifacts and improve temporal coherence, which are technically beneficial in achieving stable viewpoint sequences. The server assembles the frames into a video bitstream using a media processing library such as a command-line encoder, selecting an encoding format such as a standardized video codec.

The server uses the encoding and streaming module to convert the video bitstream into streaming-ready content. The server segments the encoded bitstream into fixed-duration segments, such as multiple-second chunks, and generates a manifest file specifying segment URLs and bitrates. The server optionally produces multiple bitrate variants by re-encoding at different resolutions or compression levels. This adaptive structure allows the terminal to switch between variants based on current network conditions, which reduces buffering, improves playback smoothness, and reduces unnecessary network load.

The server provides the manifest and segment URLs to a content delivery path, which may include a content distribution network. The server sends playback information, including a base URL of the manifest and a session identifier, to the terminal in a response message.

The terminal receives the playback information and uses a media player component to request the manifest and segments over a network. The terminal decodes the received video segments using a hardware-accelerated decoder in the terminal's system-on-chip and drives a display or head-mounted display. The terminal presents the generated viewpoint content so that the user perceives the scene from the subject's first-person perspective. For head-mounted displays, the terminal or associated device may perform lens distortion correction and head-tracking synchronization to further enhance immersion.

The server uses a feedback analysis module to collect and process user feedback. The terminal displays a control interface that allows the user to rate the generated experience, select descriptors such as “too dark,” “too fast,” “not realistic enough,” or “excellent immersion,” and adjust preference sliders such as “more dynamic camera movement,” “less motion,” or “brighter scenes.” The terminal sends this feedback to the server.

The server maintains a feedback database that stores mappings between generated content identifiers, prompt sentence variants, model parameters, and user feedback values. The server computes statistics such as average ratings per prompt pattern or per parameter configuration.

The server updates configuration rules for prompt generation based on this analysis. For example, if sequences with extreme camera motion receive lower ratings, the server reduces the probability of including phrases such as “fast camera movement” in future prompt sentences, or adjusts model parameters controlling motion amplitude.

In addition, the server can update weight values applied to different features in the text encoder's embedding or apply reinforcement learning methods to fine-tune the generative model's inference parameters. For instance, the server may define a reward function that increases with user ratings and decreases with reported discomfort and gradually adjust sampling parameters, such as step counts and guidance scales, to optimize this reward. This closed-loop adaptation is not a simple automation of human curation, but rather a machine-driven search over high-dimensional parameter spaces that cannot feasibly be explored manually. This results in improved content quality, reduced artifact frequency, and more efficient use of GPU computation per satisfactory output.

From a technical perspective, the integration of structured context construction, prompt generation, model configuration, and adaptive streaming in a single server pipeline improves computer technology in several ways. First, the use of viewpoint-reproduction context data and a context graph reduces the need to repeatedly scan large unstructured corpora, thereby reducing memory accesses and improving cache locality, leading to faster generation requests. Second, the rule-based prompt assembly combined with structured context lowers the entropy of the model's input distribution, improving convergence of the diffusion process and reducing the number of inference steps required to achieve acceptable quality, which reduces GPU time and energy consumption.

Third, the generation of adaptive bitrate streaming content directly from generated frames enables the server to tailor the encoded bitrates to each user's device capabilities and network conditions, thus reducing packet loss, retransmissions, and overall network congestion compared to transmitting a fixed high-bitrate stream. Fourth, the feedback-driven adjustment of prompt configuration and inference parameters leads to more accurate mapping between user preferences and model behavior over time, reducing the number of trial generations and discards, and thereby increasing throughput.

The server uses specific internal data structures to support these improvements. For example, the server maintains a prompt template table that includes parameterizable text fragments associated with specific context attributes, such as location, time, mood, and motion style.

The server uses an attribute vector representation for each generated scenario, where each dimension corresponds to a feature such as “indoor/outdoor,” “day/night,” “crowd density,” and “camera stability.” The server uses this attribute vector to decide which fragments to include in the prompt sentence and to set corresponding model parameters. This explicit mapping between attribute vectors and model configuration is a non-conventional processing scheme that differs from manual prompt editing and provides a reproducible, machine-executable rule set that can be optimized and extended.

In another embodiment, the server uses a different neural network architecture, such as a transformer-based video generator, in which self-attention layers encode temporal dependencies directly in the latent space. The server configures the number of layers, attention heads, and hidden dimension sizes based on available hardware resources. The server may also employ a variational autoencoder as a front-end encoder and decoder to reduce the dimensionality of video frames before generative processing, thereby enabling longer sequences under the same memory constraints. These design choices show how the system improves computational efficiency and scalability.

In another variation, the server integrates a lightweight on-device prefilter in the terminal to measure instantaneous network bandwidth and latency. The terminal periodically reports this information to the server; the server then pre-selects appropriate bitrate ladders and segment durations for upcoming content generations, which further reduces latency spikes at playback start.

The described embodiments illustrate that the server, terminal, and user cooperate in a technically specific way. The server does not merely automate human selection of content; instead, the server uses structured context data, rule-based prompt generation, and adaptive generative model configuration to modify how digital data is stored, transformed, encoded, and transmitted. These changes yield measurable technical effects such as reduced end-to-end latency, decreased bandwidth consumption, greater temporal stability of generated video, and higher correlation between user preference feedback and model output behavior. As a result, the system provides an improvement in computer technology, particularly in the fields of generative media processing, networked content delivery, and interactive multimedia systems.

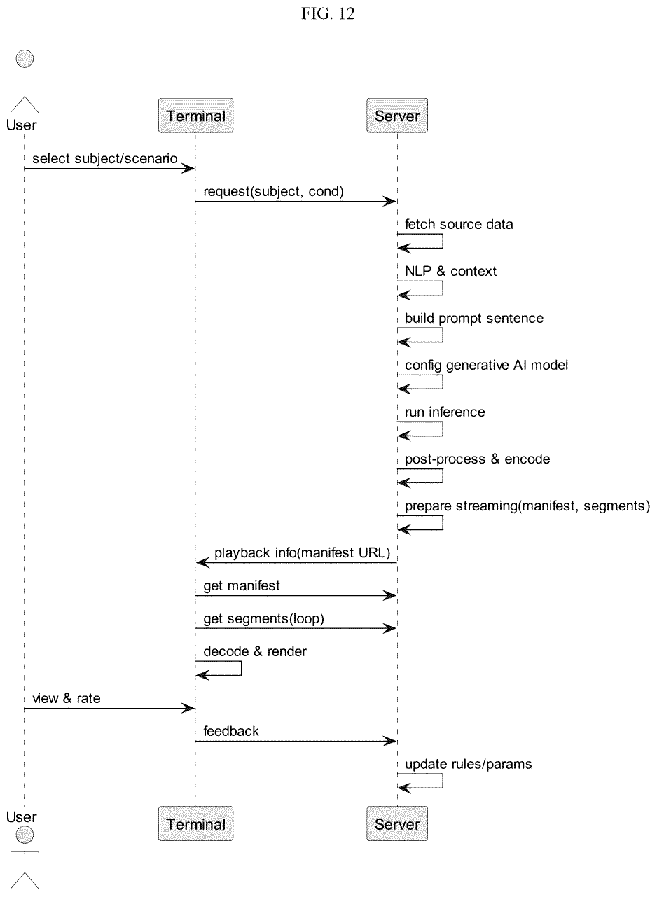

The following describes the processing flow using FIG. 12.

### Step 1

The terminal presents, on a display, a user interface listing target viewpoint subjects and scenario types. The user selects one target viewpoint subject (for example, a performer or influencer) and one desired scenario (for example, “evening walk in a city,” “backstage before performance,” or “morning routine”), and optionally specifies experience request conditions such as desired duration, resolution, mood, or time of day. The terminal generates a request message including subject identification information, information source identification information (for example, URLs or API endpoints), and the experience request conditions, and transmits this message to the server over a network using a protocol such as HTTPS.

Input: user interactions (subject selection, scenario selection, parameter values).

Output: a structured request message containing subject ID, information source IDs, and experience request conditions.

### Step 2

The server receives the request message from the terminal via a network interface and validates the message format and identifiers. The server parses the subject identification information, information source identification information, and experience request conditions, and stores them temporarily in a request context structure in main memory. The server writes a corresponding request record into a database, associating the request with a unique request identifier for tracking.

Input: request message from the terminal.

Output: an in-memory request context object and a persistent request record containing parsed identifiers and conditions.

### Step 3

The server uses a data collection module to query external information sources identified in the request. The server sends HTTP or API-specific requests (for example, REST requests) to web services, social networking services, or content platforms, using the information source identification information and the subject identification information as query parameters. The server receives response payloads containing text data, image data, and video metadata related to the target viewpoint subject, and downloads the associated media files where applicable. The server stores the raw text and media references in a raw data table in a database and stores the media files in a media storage area.

Input: request context object including subject ID and information source IDs.

Output: raw subject-related text records and media references stored in a raw data repository, and media files stored in media storage.

### Step 4

The server invokes a natural language processing module to transform the raw text data into normalized and structured text. The server reads raw text fields from the raw data table, performs tokenization, lowercasing, removal of markup tags, and emoji normalization. The server then applies a part-of-speech tagger and a named entity recognizer to detect locations, times, events, and sentiment expressions. The server computes sentiment scores using a sentiment analysis model and assigns each text record a structured representation including detected entities, sentiment, and key phrases. The server writes these structured representations into a context data table, linking each record to the corresponding subject and source.

Input: raw text records retrieved from the raw data repository.

Output: structured text records with entity fields, sentiment scores, and key phrases stored as viewpoint-reproduction context data.

### Step 5

The server executes a context structuring module to aggregate structured text records into higher-level scenario context. The server groups context records by subject, location, time window, and event type. For each group, the server constructs a context graph where nodes represent events or scenes and edges represent temporal or thematic relationships. The server computes relevance scores for each node based on occurrence frequency, recency, and sentiment intensity. The server then saves the resulting context graph, and associated node attributes, as viewpoint-reproduction context data for the target viewpoint subject in a structured graph storage.

Input: structured text records with entities and metadata.

Output: viewpoint-reproduction context graphs with nodes, edges, and relevance scores associated with the target viewpoint subject.

### Step 6

The server selects, from the viewpoint-reproduction context graphs, nodes and edges that match the user's experience request conditions. The server filters nodes by location (for example, city area), time (for example, evening period), and event type (for example, walking or backstage preparation). The server ranks the filtered nodes using the relevance scores and the closeness to requested mood (derived from sentiment scores). The server outputs a set of selected nodes and associated descriptive attributes (for example, scene descriptions, typical objects, environmental sounds) to a prompt assembly structure.

Input: viewpoint-reproduction context graphs and experience request conditions.

Output: a selected context subset consisting of ranked nodes and descriptive attributes relevant to the requested scenario.

### Step 7

The server uses a prompt generation module to construct a prompt sentence for a generative AI model based on the selected context subset and the experience request conditions. The server retrieves template fragments for first-person viewpoint instructions, environmental descriptions, and motion characteristics from a prompt template store. The server combines these fragments with attributes from the selected context nodes, inserting specific descriptions such as “river,” “street lights,” or “backstage equipment.” The server enforces predefined rules to ensure that the prompt sentence contains explicit first-person instructions and avoids conflicting descriptors. The server generates a final prompt sentence string and attaches it to the request context.

Input: selected context subset and prompt template fragments.

Output: a constructed prompt sentence describing the desired first-person viewpoint content.

### Step 8

The server optionally refines the constructed prompt sentence using a language model. The server sends the initial prompt sentence and control instructions (for example, “improve fluency and keep all constraints”) to a text-generation component. The server receives a revised prompt sentence and checks that required constraint terms (for example, “first-person POV,” subject role, and key environmental attributes) are present. The server replaces or keeps the initial prompt sentence based on this validation.

Input: initial prompt sentence and control instructions.

Output: a validated and optionally refined prompt sentence ready for use by the generative AI model.

### Step 9

The server configures a generative AI model for inference. The server determines a model type (for example, image generator or video generator) based on the requested media type and duration. The server calculates required resolution and frame rate from the experience request conditions and device capabilities reported by the terminal. The server sets inference parameters such as number of diffusion steps, guidance scale, and sampling method. The server loads the corresponding neural network weights into GPU memory and prepares the text encoder and generator components for execution.

Input: validated prompt sentence, experience request conditions, and system resource information.

Output: a configured generative AI model instance with specified inference parameters ready for content generation.

### Step 10

The server executes the generative AI model inference using the configured model and prompt sentence. The server encodes the prompt sentence into a text embedding vector using a transformer-based text encoder. The server initializes latent tensors with random noise and iteratively applies the denoising U-Net or transformer-based generator conditioned on the text embedding. At each inference step, the server updates the latent tensors according to the diffusion schedule and guidance parameters. After completing the designated number of steps, the server decodes the final latent tensors into pixel-space images or a sequence of frames using a decoder network. The server stores the generated images or frames in a temporary media buffer and associates them with the request identifier.

Input: configured generative AI model and prompt sentence embedding.

Output: generated image frames or video frames representing the requested first-person viewpoint content.

### Step 11

The server performs post-processing on the generated image frames or video frames. The server applies image quality correction operations such as denoising, super-resolution upscaling, color balance adjustment, and contrast tuning using image processing algorithms or additional neural networks. For video, the server applies temporal smoothing or frame interpolation to ensure smooth motion and consistent perspective. The server then assembles the processed frames into a continuous video bitstream using a media processing library, encoding the stream with a selected codec and storing the encoded bitstream in a storage location for streaming preparation.

Input: raw generated frames from the generative AI model.

Output: a processed and encoded video bitstream suitable for streaming conversion.

### Step 12

The server converts the video bitstream into streaming content. The server segments the bitstream into multiple time-based segments of fixed duration and generates a manifest file listing segment URLs and timing information. The server optionally creates multiple bitrate variants by re-encoding the video at different resolutions or compression levels and generates a manifest that references all variants. The server registers the manifest location and segment paths in a streaming metadata store, and generates playback information including a manifest URL and available bitrate profiles.

Input: processed and encoded video bitstream.

Output: segmented streaming files, one or more manifests, and playback information containing manifest URL and bitrate options.

### Step 13

The server sends a response to the terminal containing the playback information. The terminal receives the playback information, parses the manifest URL and available bitrate profiles, and initializes a media player component. The terminal selects an initial bitrate according to device capability and estimated network throughput and requests the manifest file from the server or content distribution network. The terminal begins requesting segment files sequentially according to the manifest.

Input: playback information from the server.

Output: active media player state on the terminal prepared to request and decode streaming segments.

### Step 14

The terminal downloads streaming segments and decodes the video content. The terminal receives each segment via the network interface and feeds the encoded data into a hardware or software decoder. The terminal decodes the video frames and renders them onto the display or into a head-mounted display view. The terminal monitors playback buffer levels and network throughput; if conditions change, the terminal adjusts the selected bitrate profile by switching to higher or lower bitrate segments as indicated by the manifest, maintaining smooth playback.

Input: streaming segments and manifest data.

Output: decoded video frames presented to the user as first-person viewpoint content.

### Step 15

The user views the presented first-person viewpoint content on the terminal. The user may interact with playback controls to pause, resume, or seek within the sequence. During or after viewing, the user provides feedback through the terminal interface, such as rating the experience, selecting qualitative tags (for example, “too shaky,” “perfect immersion,” “too dark”), or adjusting preference sliders. The terminal collects this feedback data and transmits a feedback message to the server linked to the corresponding request identifier and content identifier.

Input: visual presentation of content and user interactions with the interface.

Output: feedback message containing ratings, tags, and preference adjustments.

### Step 16

The server receives the feedback message and updates internal configuration rules. The server parses the ratings and qualitative tags, associates them with the specific prompt sentence and inference parameters used for that content, and logs the feedback in a feedback database. The server computes aggregated statistics such as average rating per prompt pattern and correlation between parameter values (for example, guidance scale or motion level) and user satisfaction. Based on predefined optimization rules, the server modifies prompt template weights, adjusts default inference parameters, or updates negative prompt elements for future generations. These updates are stored in configuration tables that will be consulted in subsequent executions of the prompt generation module and generative AI model inference module.

Input: feedback message containing evaluation information and preference changes.

Output: updated prompt configuration rules and generative model parameter settings used to adapt future content generation.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional content distribution systems that rely on generative AI models typically accept manually authored prompt sentences and generate images or videos in a generic, third-person style. Such systems suffer from several technical limitations. First, the systems lack an automated pipeline for acquiring heterogeneous source data, including visual data and textual data, from distributed information sources, and for converting that data into structured feature representations suitable for downstream prompt generation. As a result, the utilization of available data is inefficient, and significant manual intervention is required in configuring the generative AI model.

Second, known systems generally do not integrate image analysis processing and natural language analysis processing in a coordinated manner to extract context-level features such as situation, place, time zone, and action content of a particular subject provider, and thus cannot reliably generate first-person viewpoint content that faithfully reproduces the subject provider's daily perspective. This leads to technically suboptimal prompt sentences that under-specify scene conditions and viewpoint constraints, causing unstable output quality and increased computational waste due to repeated generation attempts.

Third, existing systems rarely adapt the behavior of the generative AI model in real time based on a user's emotional state or engagement context. They typically deliver static, non-adaptive content, even when user-side sensors or interaction logs provide signals that could be used to adjust generation parameters. Consequently, processing resources in the generative AI pipeline are not optimally allocated, and user devices receive content that may not match the user's current cognitive state, reducing effective system performance per unit of compute.

Fourth, widely used recommendation mechanisms usually operate at the level of static metadata (e.g., title, genre) and do not use fine-grained feature information derived from the generative pipeline itself, such as extracted context patterns or prompt-generation rules. Such architectures hinder the ability of the system to prioritize and schedule generation or distribution of experience products that are likely to yield higher user engagement, and they prevent feedback signals, such as user evaluations and usage histories, from being fed back into the prompt generation logic and generative AI configuration in a systematic, closed-loop manner.

Therefore, there is a need for a system architecture and processing method that: (i) automatically acquires and structurally analyzes multi-modal data related to a subject provider, (ii) programmatically generates detailed prompt sentences for a generative AI model reflecting first-person viewpoint constraints, (iii) dynamically adjusts generation conditions in response to the user's emotional state, and (iv) updates prompt-generation rules and model input conditions using aggregated feedback. Such a system should improve the overall operation of the computer-based content generation pipeline itself, including data acquisition efficiency, feature extraction accuracy, generative model conditioning, and adaptive delivery of generated content.

The specific processing by the specific processing unit 290 of the data processing device 12 in Example 2 is realized by the following means.

The present invention provides a server comprising a processor and a memory storing instructions which, when executed by the processor, cause the server to automatically acquire, from at least one information source related to a subject provider, a data set including visual information and character information and store the data set in a storage region; analyze still image information and moving image information included in the data set by executing image analysis processing, and analyze character string information included in the data set by executing natural language analysis processing, thereby extracting feature information related to a situation, a place, a time zone, and an action content of daily behavior of the subject provider; generate a prompt sentence based on the feature information, the prompt sentence describing conditions including a first-person viewpoint from the subject provider, a scene, a time zone, an action content, and an atmosphere, and input the prompt sentence to a generative AI model to cause the generative AI model to generate visual data reproducing the viewpoint of the subject provider; recognize an emotional state of a user and adjust content of the prompt sentence or generation conditions of the generative AI model according to the emotional state to change content of content to be generated; and manage the generated visual data as an experience product, present information related to the experience product to a user terminal by an online providing function, and, in response to a purchase request or a use request, distribute the visual data to the user terminal. This enables an integrated and computer-implemented pipeline in which multi-modal data related to a subject provider is transformed into structured feature information, automatically converted into first-person-viewpoint prompt sentences for a generative AI model, dynamically conditioned based on user emotional signals, and fed back using user behavior data, thereby improving the technical performance, efficiency, and adaptability of the computer system for generating and delivering personalized visual content.

The term “system” refers to a combination of one or more computing devices, storage devices, communication interfaces, and software components that cooperate to execute the processing described in the claims.

The term “processor” refers to a hardware computation unit, such as a central processing unit or a graphics processing unit, configured to execute instructions and perform arithmetic and logical operations.

The term “memory” refers to a non-transitory computer-readable storage medium, including volatile and non-volatile storage, that stores instructions and data for use by the processor.

The term “information source” refers to any data-providing medium or service, including network-based services, from which data related to a subject provider can be obtained.

The term “subject provider” refers to an individual or an organization whose activities, viewpoints, or daily life serve as the basis for generating visual data in the system.

The term “data set” refers to a collection of one or more data items, including visual information and character information, acquired from one or more information sources.

The term “visual information” refers to information representing images or videos, including still image data and moving image data, that can be processed by image analysis functions.

The term “character information” refers to information expressed as text or character strings, such as captions, titles, comments, and metadata associated with visual information.

The term “storage region” refers to a logical or physical area of a storage device in which the system stores the data set and related processing results.

The term “still image information” refers to visual information consisting of a single image frame or a plurality of independent image frames.

The term “moving image information” refers to visual information composed of a temporal sequence of image frames that represent video content.

The term “image analysis processing” refers to a sequence of computational operations applied to visual information for detecting or classifying objects, scenes, or features, including but not limited to object detection, scene recognition, and feature extraction.

The term “natural language analysis processing” refers to a sequence of computational operations applied to character information for interpreting or structuring textual content, including but not limited to tokenization, part-of-speech tagging, parsing, and keyword extraction.

The term “feature information” refers to structured data that represents extracted attributes or characteristics, including situation, place, time zone, and action content, derived from the data set by analysis processing.

The term “situation” refers to a contextual state associated with an activity of the subject provider, including circumstances, environment, and background conditions.

The term “place” refers to a physical or virtual location associated with the subject provider's activity, such as an indoor environment, an outdoor environment, or a transportation setting.

The term “time zone” refers to a temporal attribute associated with the subject provider's activity, including time-of-day categories such as morning, afternoon, evening, or night.

The term “action content” refers to an activity or behavior performed or implied to be performed by the subject provider, including movements, operations, or interactions with objects or environments.

The term “prompt sentence” refers to a natural-language instruction or description provided as input to a generative AI model to specify conditions for content generation.

The term “first-person viewpoint” refers to a viewpoint that simulates visual perception as if seen from the eyes or perspective of the subject provider.

The term “scene” refers to a coherent visual configuration that includes at least a setting, objects, and spatial relationships appearing in generated visual data.

The term “atmosphere” refers to qualitative characteristics of a scene, such as mood, tone, or style, including brightness, color impression, and emotional nuance.

The term “generative AI model” refers to a machine learning model that receives an input, including a prompt sentence, and automatically produces new data, such as images or videos, that are not explicitly stored in advance.

The term “visual data” refers to generated digital content in the form of images or videos produced by the generative AI model in response to a prompt sentence.

The term “viewpoint of the subject provider” refers to a visual perspective in generated visual data that is configured to reproduce how a scene would appear from the position and orientation of the subject provider.

The term “emotional state” refers to a condition representing a user's affective response, such as interest, excitement, calmness, or dissatisfaction, estimated by the system from sensor data, interaction data, or explicit input.

The term “content of the prompt sentence” refers to specific textual elements included in a prompt sentence, such as descriptions of viewpoint, scene, time, action, and atmosphere.

The term “generation conditions of the generative AI model” refers to parameters or settings that influence the behavior of the generative AI model during content generation, including control variables, sampling parameters, and conditioning vectors.

The term “experience product” refers to a unit of generated visual data, together with associated metadata, that is managed and provided by the system as content to be consumed by a user.

The term “online providing function” refers to a function executed by the system that makes information or content available to a user terminal through a communication network.

The term “user terminal” refers to an end-user device, such as a smartphone, tablet, personal computer, or head-mounted display, capable of communicating with the system and presenting visual data to a user.

The term “purchase request” refers to a request transmitted from a user terminal to the system indicating that the user desires to obtain usage rights to an experience product in exchange for a consideration.

The term “use request” refers to a request transmitted from a user terminal to the system indicating that the user desires to access or play back an already-available experience product.

The term “distribute the visual data” refers to transmitting or making accessible the generated visual data from the system to the user terminal, including streaming or downloading.

The term “purchase history information” refers to data representing records of products or services previously obtained by the user through the system or related services.

The term “preference information” refers to data indicating tendencies or interests of the user, derived from explicit settings, interaction behavior, or inferred patterns.

The term “individualized product recommendation” refers to a process in which the system selects and presents one or more experience products based on purchase history information and preference information of a particular user.

The term “evaluation information” refers to feedback data provided by the user, such as ratings, comments, or satisfaction indicators, relating to experience products.

The term “use history information” refers to data describing how a user has interacted with experience products, including viewing times, frequency, duration, and playback operations.

The term “generation rules of the prompt sentence” refers to logical or algorithmic procedures used by the system to construct prompt sentences from feature information and other contextual information.

The term “input conditions to the generative AI model” refers to the configuration of data and parameters supplied to the generative AI model, including prompt sentences, control codes, and numerical settings that affect output characteristics.

The term “content to be generated subsequently” refers to visual data that will be generated at a later time by the generative AI model in response to updated prompt sentences or input conditions.

In one embodiment, a server includes a processor, a memory, a network interface, and at least one storage device. The server executes an operating system such as a general-purpose server operating system and runs application software implemented, for example, in a high-level programming language. The server is connected via a communication network to at least one terminal operated by a user. The terminal includes a display unit, an input unit, a local processor, and a communication module. The terminal executes an application program that interacts with the server through a network protocol.

The server implements a data acquisition module, an analysis module, a prompt generation module, a generative AI interface module, an emotional state adaptation module, and a content management and delivery module. The memory of the server stores instructions for each module and data structures including raw data sets, feature information, prompt sentences, generated visual data metadata, user information, and experience product catalogs.

The server uses a persistent storage device to store large-capacity media content, such as images and videos, as well as database records.

The server uses a data acquisition module to obtain a data set related to a subject provider from one or more information sources. The server accesses online services that provide public media associated with the subject provider, such as social networking services and video sharing platforms. The server uses a network interface to send HTTP requests and to receive HTML documents, media files, and metadata responses. The server may employ a web scraping framework such as a browser automation framework to control a headless browser process executed on the server hardware. The server uses a document parsing library to traverse document object models and identify uniform resource locators of images and videos, captions, comments, and timestamp fields.

The server stores the acquired media files in a structured storage region. The server assigns a unique identifier to each media item and records in a relational database a mapping between the identifier, a storage path in an object store, and associated textual metadata. The server thus forms a multi-modal data set that contains visual information (still images and videos) and character information (captions, comments, titles, and tags).

The server uses the analysis module to perform image analysis processing on the visual information. The server may execute a computer vision library such as a general-purpose image processing library in combination with a deep learning inference engine. In one configuration, the server loads a pre-trained convolutional neural network model for object detection, such as a multi-layer convolutional architecture with feature pyramid layers and anchor-based detection heads. The server applies the network to each still image or to sampled frames of each video, thereby generating bounding boxes, class labels, and confidence scores for objects present in the scene.

The server also executes scene classification by applying a convolutional neural network trained on scene categories. The network outputs probability distributions over scene types (for example, indoor café, office, street, park, transportation cabin), and the server selects the class with a probability above a predetermined threshold as the scene label. The server optionally performs person detection and pose estimation using a separate neural network module, thereby identifying activities that involve body posture or motion.

For videos, the server uses a video decoding library to read frames at a predetermined interval, such as one frame per second, and accumulates object and scene detections across time. The server uses an aggregation algorithm, for example, a weighted voting scheme, to determine dominant objects and scenes across the temporal sequence. The server computes statistical features such as the occurrence frequency of “cup,” “table,” “screen,” “window,” or “road” objects, and uses these features to infer contexts corresponding to daily behavior patterns of the subject provider.

The server uses the analysis module to perform natural language analysis processing on the character information. The server executes a natural language processing toolkit to tokenize textual strings, normalize words (for example, by lemmatization), and remove stop words.

The server then applies part-of-speech tagging to identify nouns, verbs, and adjectives, and extracts key terms related to locations (for example, café, office, gym), activities (for example, drinking, working, jogging), and temporal expressions (for example, morning, night, weekend). The server may use a term frequency-inverse document frequency (TF-IDF) scheme to identify salient words for each subject provider. The server may further perform named-entity recognition to distinguish place names and event names.

The server combines the outputs of the image analysis processing and the natural language analysis processing in a feature integration submodule. The server defines, in memory, a feature record structure that includes fields such as provider identifier, context identifier, scene label, location type, time-of-day category, activity label, and an occurrence score. The server uses a rule-based classifier, where rules associate combinations of visual detections and textual keywords with context labels. For example, if the visual detections include objects “cup” and “table,” and textual analysis reveals words “coffee” and “morning,” the server assigns a context identifier such as “morning_cafe_coffee” and sets the time-of-day field to “morning” and location field to “café.” The server stores each feature record in a database table dedicated to context features.

The server uses the prompt generation module to construct prompt sentences based on the feature information. The server implements this module using a template-based text generation algorithm. The server defines several parameterized templates for different context types. An example template for a café context may be:

“Generate a first-person view [media_type] from the subject provider's perspective, [activity_phrase] at a [location_descriptor] on a [time_of_day_descriptor], with [atmosphere_descriptor].”

The server fills the placeholders using the feature record values. When the context is “morning_cafe_coffee,” the server may generate the following prompt sentence:

“Generate a first-person view video from the subject provider's perspective, sitting at a small café table on a sunny morning, holding a cup of coffee with steam rising, and looking out through a large window at a quiet street.”

In another example, when the context indicates jogging near water at sunset, the server generates:

“Generate a first-person view video from the subject provider's perspective, jogging along a riverside path at sunset, with the rhythmic motion of footsteps and warm orange light reflecting on the water.”

For an office work context, the server generates:

“Generate a first-person perspective image from the subject provider's eyes, sitting at a wooden desk in a modern office, with a laptop open, a notebook and a pen nearby, and soft daylight coming from a window on the left.”

The server stores each generated prompt sentence in a prompt table, associated with the corresponding feature record and metadata such as a target media type (image or video), target resolution, and duration.

The server uses the generative AI interface module to communicate with a generative AI model. In one embodiment, the generative AI model is an image generation neural network based on a transformer architecture or a generative adversarial network architecture. The server may execute the model locally on a graphics processing unit or access the model via an inference application programming interface provided by a remote computing resource. The model receives text tokens corresponding to the prompt sentence and generates visual data that satisfies the conditions expressed in the prompt.

When the model is a transformer-based text-to-image architecture, the server tokenizes the prompt sentence into subword tokens and converts the tokens into embedding vectors using a learned embedding matrix. The server passes the sequence of embeddings through multiple self-attention blocks and feedforward networks to produce a latent representation. The server then uses a decoder network, which may be a deconvolutional neural network, to synthesize an image from the latent representation. When the model is a video generation architecture, the server extends the decoder to generate sequences of frames, representing time steps, from a spatio-temporal latent representation.

The server trains or fine-tunes the generative AI model using a training data set consisting of image-text or video-text pairs. The server uses a loss function that may include a reconstruction loss (for example, L2 or L1 distance between generated and reference images), an adversarial loss (when using a generative adversarial structure), and a perceptual loss computed in a feature space of a pre-trained network. During training, the server updates the model weights using a gradient-based optimization algorithm such as stochastic gradient descent with momentum or an adaptive method. The server may employ data augmentation techniques such as random cropping, flipping, color jittering, and time subsampling to improve generalization. These training details enable the system to map prompt sentences to visual outputs with improved fidelity and stability compared to heuristic or rule-based image synthesis.

The server uses the emotional state adaptation module to adjust prompt sentences or generation conditions in accordance with a user's emotional state. The terminal may obtain biometric or interaction signals, such as facial expressions captured by a camera, touch interaction patterns, or playback control patterns, and transmit feature values to the server.

The server may use a trained classifier implemented as a neural network or other statistical model to map the feature values to discrete emotional states such as “relaxed,” “excited,” or “bored.” The classifier may be a multi-layer perceptron that receives numerical features and outputs a probability distribution over emotional categories, trained using supervised learning and a cross-entropy loss function.

When the server recognizes a particular emotional state, the server modifies either the prompt content or the generation parameters. For example, when the user appears stressed, the server may adjust the atmosphere descriptor in the prompt to produce calmer scenes, such as replacing “busy café” with “quiet café” or reducing motion intensity descriptors. When the user appears bored, the server may instruct the generative AI model to increase variation by changing random seeds, sampling temperature, or adding additional dynamic elements to the scene. The server thereby uses the emotional state as a control signal to steer the generative pipeline, which reduces the number of iterations of re-generation and increases the alignment between the generated content and the user's current state, yielding a technical improvement in generation efficiency and perceived quality.

The server uses the content management and delivery module to register generated visual data as experience products. The server stores the generated files in a media storage service, assigns experience identifiers, and records descriptive metadata, including references to the underlying prompt sentence, context, and generation parameters. The server indexes the experience products in a catalog structure optimized for retrieval based on user attributes and context features.

The terminal communicates with the server to retrieve catalog data. The terminal displays thumbnails, titles, and short textual descriptions of experience products. The user selects an experience product on the terminal by operating the input unit. The terminal sends selection and, if necessary, purchase information to the server. The server verifies the user's authorization using an authentication and billing subsystem and then generates a session-specific content access token or a signed uniform resource locator. The terminal uses a media player library to stream or download the visual data from the server or from a content distribution node. The terminal decodes the visual data using hardware acceleration, when available, and presents the video or image on the display.

The server records user interactions, such as content played, playback duration, and evaluations if the user provides ratings or comments. The server aggregates these data points in a feedback database. The server analyzes aggregated usage history information using statistical methods or machine learning models to identify which contexts, prompt patterns, and generative parameters correlate with high engagement and satisfaction. The server then updates the generation rules of the prompt sentences. For example, if feedback indicates that users respond favorably to explicit descriptions of lighting (“warm sunset light,” “soft morning light”), the server increases the likelihood of including such attributes in future prompts. If users frequently skip content with high motion blur, the server adjusts the generative model input conditions to reduce motion blur descriptors.

By feeding usage data back into the prompt generation and generative AI conditioning components, the server improves the precision of content generation and reduces the need for manual tuning. This closed-loop adjustment operates on internal data structures (feature records, prompt templates, parameter vectors) and modifies neural network input conditions, thereby improving the overall computational efficiency and accuracy of the content generation pipeline.

The server, by tightly coupling image analysis, natural language processing, structured feature extraction, template-driven prompt generation, and generative AI model control, achieves technical effects beyond mere automation of human creative tasks. The server uses structured feature records to constrain and condition generative inference, which reduces unnecessary search in the output space and lowers computational load per acceptable output.

The server's integration of multi-modal analysis, emotional state adaptation, and feedback-driven rule updating leads to improved convergence of the generative model towards user-preferred outputs, thereby reducing re-generation cycles and network bandwidth associated with transmitting unsatisfactory content.

In a variation, the server may implement different neural network architectures for the generative AI model, such as a diffusion-based generative model in which the server applies a denoising process guided by the prompt sentence. In this case, the server encodes the prompt into an embedding space and injects the embedding into each denoising step using a cross-attention mechanism. The server adjusts the scale of classifier-free guidance parameters according to the context and emotional state, allowing fine control over the trade-off between adherence to the prompt and image diversity. This adjustment leads to improved image fidelity without significantly increasing computation time.

In another embodiment, the server may use a graph-based feature structure instead of a simple record, where nodes represent entities such as “location,” “object,” “activity,” and edges represent relationships such as “performed_at” or “contains.” The server performs graph-based reasoning to derive higher-order contexts and thereby generates richer prompt sentences. This data structure enables more efficient retrieval and combination of context elements when constructing prompts and improves the coverage of possible scene configurations.

In yet another embodiment, the terminal may be a head-mounted display device. The server generates panoramic or stereoscopic visual data in response to prompt sentences that specify head orientation and depth cues. The terminal renders the visual data as an immersive environment controlled by the user's head motion, which is tracked by sensors in the terminal. The server configures the generative AI model to output image pairs or spherical projections, and this configuration constitutes a control of a technical display device that improves the user's immersive experience.

Across these embodiments, the server uses specific data structures, algorithmic flows, and neural network configurations to transform raw multi-modal data into personalized, first-person-viewpoint content. The resulting system improves computational efficiency by constraining generative search with automatically extracted features, enhances accuracy by aligning model input conditions with real-world patterns and user states, and reduces communication overhead by prioritizing content likely to satisfy the user. These effects derive from the specific cooperation between the server, the terminal, and the generative AI model, and thus represent an improvement to computer technology itself rather than an abstract automation of human decision making.

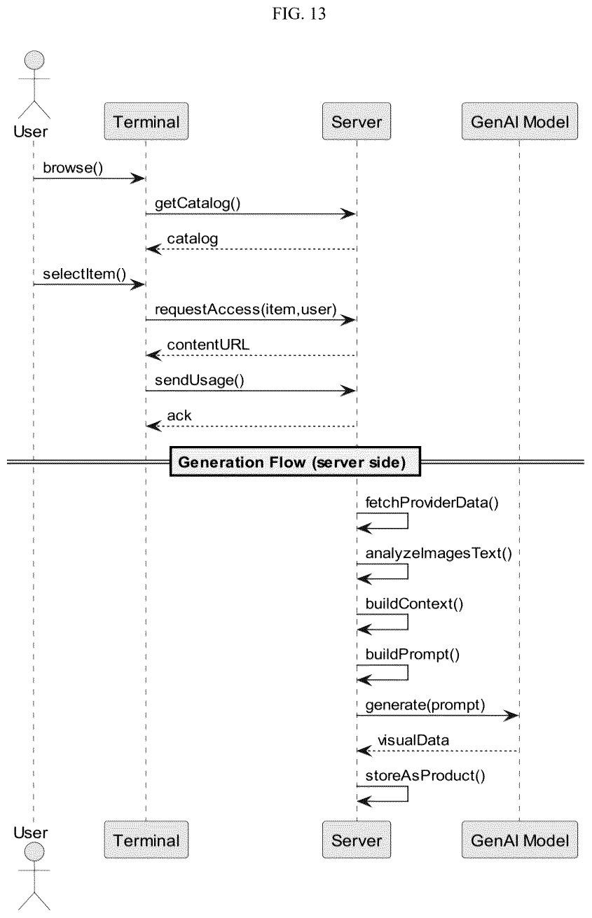

The following describes the processing flow using FIG. 13.

### Step 1

The server acquires provider-related source data.

The server receives, as input, registration information specifying a subject provider, including one or more account identifiers or content URLs associated with network information sources. The server uses the network interface to send HTTP requests to these information sources and obtains, as raw responses, hypertext documents, media file URLs, and metadata.

The server executes a scraping routine that controls a headless browser or HTTP client, parses document structures, and extracts links to image files, video files, and associated text such as captions and comments. The server then downloads the referenced media files and stores the binary media data and the textual metadata in a storage region, thereby outputting a multi-modal data set containing visual information and character information for the subject provider.

### Step 2

The server normalizes and indexes the acquired data.

The server takes, as input, the multi-modal data set stored in the storage region. The server assigns a unique identifier to each media item, computes basic attributes such as file size, resolution, duration (for video), and encoding format, and stores these attributes in a relational database. The server also converts character information into a normalized internal representation by applying character encoding normalization and removing invalid characters. The server thus outputs an indexed data set in which each media item can be efficiently retrieved by identifier, provider, and timestamp, enabling subsequent analysis modules to access consistent input structures.

### Step 3

The server performs image analysis on still and moving images.

The server receives, as input, the visual information (image files and video files) referenced by the indexed data set. For still images, the server loads each image into memory and applies a convolutional neural network-based object detection model to compute, for each image, a set of detected objects with class labels, bounding box coordinates, and confidence scores.

For moving images, the server decodes video frames at a predetermined interval, for example one frame per second, and applies the same or a similar object detection model to each frame.

The server aggregates detection results across frames by summing or averaging confidence scores for identical classes. The server also applies a scene classification model to each image or representative frame, computing probabilities for scene categories and selecting the category with the highest probability as the scene label. The server outputs, for each media item, a visual feature record containing detected objects, scene label, and corresponding scores.

### Step 4

The server executes natural language analysis on textual data.

The server uses, as input, the character information (captions, titles, comments, and tags) associated with each media item. The server tokenizes the text into word units, removes stop words, performs lemmatization to convert inflected forms into base forms, and applies part-of-speech tagging to label words as nouns, verbs, adjectives, or other grammatical categories.

The server then extracts candidate location terms, activity terms, and temporal expressions by applying rule-based filters and vocabulary lists. The server may compute term frequencies and TF-IDF values to determine which terms are salient for a given subject provider. The server outputs, for each media item, a textual feature record including extracted keywords, their categories (location, activity, time), and relevance scores.

### Step 5

The server integrates visual and textual features to derive context features.

The server takes, as input, the visual feature records and the textual feature records that share a common media identifier. The server combines these records by aligning them using the shared identifier and applies a set of integration rules. For example, when the visual features include objects such as “cup” and “table” and the textual features include words such as “coffee” and “morning,” the server applies a rule that maps this combination to a context labeled “morning_cafe_coffee.” The server also assigns a time-of-day category based on temporal expressions, and a location category based on scene labels and location words. The server computes a context occurrence score using a weighted sum of detection confidences and textual relevance scores. The server outputs a context feature record that summarizes, for each recurring situation, a context identifier, a location type, a time-of-day type, an activity label, and the occurrence score.

### Step 6

The server selects target contexts for generative content.

The server receives, as input, the set of context feature records generated in Step 5. The server applies selection criteria such as a minimum occurrence score threshold, recency of underlying media, and diversity across contexts to avoid redundancy. The server may sort context feature records by occurrence score and select the top N records for a given provider.

The server outputs a subset of context feature records designated as target contexts for which prompt sentences and generative content are to be created.

### Step 7

The server generates prompt sentences from context features.

The server uses, as input, each selected context feature record. The server determines a template type based on the context identifier and associated attributes, such as whether the content should be an image or a video, and what level of motion or interaction is implied. The server fills template slots with parameters derived from the context features, such as location descriptors, time-of-day descriptors, activity phrases, and atmosphere descriptors. For example, when the context is “morning_cafe_coffee,” the server generates a prompt sentence such as:

“Generate a first-person view video from the subject provider's perspective, sitting at a small café table on a sunny morning, holding a cup of coffee with steam rising, and looking out through a large window at a quiet street.”

When the context indicates jogging at sunset, the server generates a prompt sentence such as: “Generate a first-person view video from the subject provider's perspective, jogging along a riverside path at sunset, with the rhythmic motion of footsteps and warm orange light reflecting on the water.”

The server stores each generated prompt sentence in a prompt repository along with a reference to the originating context feature record and outputs the repository entries for use by the generative AI model.

### Step 8

The server configures generative AI model input conditions.

The server takes, as input, a prompt sentence and associated generation parameters, such as desired resolution, video length, and style intensity. The server tokenizes the prompt sentence into tokens, maps the tokens to numerical embeddings, and arranges the embeddings into a sequence tensor. The server sets model-specific parameters, including sampling temperature, guidance scale, random seed, and number of inference steps (for diffusion-style models), or noise vector dimension and truncation threshold (for adversarial-style models). The server thus outputs a fully specified model input package comprising the embedded prompt representation and numeric configuration parameters.

### Step 9

The server invokes the generative AI model to generate visual data.

The server uses, as input, the model input package from Step 8. The server executes the generative AI model on a processor, such as a graphics processing unit, performing forward propagation through multiple layers of the network. In a transformer-based architecture, the server passes the prompt embeddings through self-attention layers and feedforward blocks to produce a latent representation, then decodes the latent representation into an image or a sequence of frames. In a diffusion-based architecture, the server iteratively refines a noise tensor over a plurality of denoising steps, each step conditioned on the prompt embeddings, to obtain a clean image or video. The server obtains as output an image tensor or video tensor that represents visual data satisfying the prompt sentence and generation conditions.

### Step 10

The server encodes and stores the generated visual data.

The server receives, as input, the image tensor or video tensor produced by the generative AI model. The server converts the tensor into a standard media format. For an image tensor, the server performs color space conversion if necessary and encodes the data into a compressed image file format. For a video tensor, the server encodes the sequence of frames using a video codec and packages the encoded stream into a container format. The server then writes the encoded file to a storage device, records a storage path, and creates a metadata entry linking the generated file to its prompt sentence, context feature record, and generation parameters.

The server outputs a persistently stored visual content item ready to be managed as an experience product.

### Step 11

The server manages experience products and builds a catalog.

The server uses, as input, the metadata entries and storage paths of generated visual content items. The server assigns a unique experience identifier to each item, generates or selects a representative thumbnail image, and compiles descriptive fields such as title, short description, and tags. The server inserts catalog entries into a database table optimized for retrieval by provider, context, and user preference. The server thus outputs a structured catalog that can be queried by the terminal for browsing and selection.

### Step 12

The terminal retrieves and displays the catalog to the user.

The terminal uses, as input, user identification data and browsing requests entered by the user through the input unit. The terminal sends requests to the server via a communication module and receives, as output, catalog entries containing experience identifiers, titles, thumbnails, and brief descriptions. The terminal renders the thumbnails and descriptions on the display in a list or grid layout. The user views the presented catalog and interacts with the interface to select items of interest.

### Step 13

The user selects an experience and initiates access.

The user observes the catalog displayed on the terminal and selects a particular experience by operating the input unit, such as tapping a thumbnail. The terminal receives, as input, the user's selection action, and transmits a selection request to the server, identifying the selected experience and the user account. The terminal then waits for a response indicating whether the user may access the experience, based on purchase history and authorization status.

### Step 14

The server authorizes access and provides a content URL.

The server uses, as input, the selection request from the terminal, which includes a user identifier and an experience identifier. The server queries the database to verify whether the user has already purchased the experience or has the right to access it. If necessary, the server initiates a purchase process and records the result. When access is authorized, the server generates or retrieves a secure content uniform resource locator, which may be a time-limited, signed link to the stored media file. The server outputs this secure URL and sends it to the terminal in a response message.

### Step 15

The terminal streams or downloads the visual data and presents it.

The terminal receives, as input, the secure content URL from the server. The terminal initializes a media playback component, requests the media data from the specified URL, and receives streamed or downloaded data packets. The terminal decodes the media stream using a codec implementation on the local processor and renders the resulting frames on the display. The user visually experiences the generated first-person viewpoint content on the terminal. The terminal may further collect playback events such as play, pause, and stop, and send these events back to the server as usage history data.

### Step 16

The server collects feedback and updates prompt generation rules.

The server uses, as input, usage history data and evaluation information transmitted from the terminal, including viewing durations, completion rates, skip actions, and explicit ratings or comments from the user. The server aggregates these data across users and experiences and computes metrics such as average watch time and satisfaction scores per context and per prompt pattern. The server analyzes correlations between prompt attributes (for example, explicit lighting descriptions, motion descriptors) and engagement metrics. Based on this analysis, the server updates internal rule sets or weighting parameters used in Step 7 when generating prompt sentences, such as increasing the probability of including certain descriptors or adjusting default generation parameters. The server outputs updated prompt generation rules and model input configurations that are applied in subsequent executions of the generative pipeline, thereby improving the accuracy and efficiency of future content generation.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content delivery systems, including systems that utilize machine learning or generative models, primarily focus on static recommendation and one-way distribution of pre-authored media. Such systems typically generate or select content in advance based on coarse-grained user attributes or historical preferences, and then deliver the same content stream regardless of the user's real-time state. As a result, these systems suffer from several technical shortcomings.

First, conventional systems do not tightly couple the analysis of heterogeneous electronic information sources (such as text posts, images, and videos obtained from network-based publishing platforms) with automated construction of machine-understandable prompt sentences for a generative AI model. In many cases, human operators manually craft prompts, or prompts are generated using fixed templates with little awareness of the underlying scene context, viewpoint, or emotional tone. This leads to suboptimal utilization of the generative AI model and reduces the quality, consistency, and controllability of generated visual content. The system therefore fails to efficiently transform raw, unstructured data into generation instructions that match a target viewpoint or scenario in a computationally robust manner.

Second, existing systems do not integrate real-time user emotion recognition into the content generation and editing pipeline at a system level. Emotion analysis, if present, is often isolated from the generation process and used only for coarse recommendation. Conventional systems generally lack a closed feedback loop where the user's facial and voice signals are continuously analyzed, mapped to an estimated emotional state, and then used to dynamically adjust prompt sentences or editing rules during or between playback sessions. Consequently, the system cannot technically adapt its content pipeline at runtime to improve relevance and responsiveness, and it cannot improve generative performance based on fine-grained, temporally aligned emotion data.

Third, many known systems do not maintain and exploit a structured usage history that unifies prompt sentences, emotional states, content data, purchase behavior, viewing behavior, and user feedback. Without such a unified history, the system cannot effectively learn how specific prompt constructions, scene types, and emotion-aware editing policies correlate with user satisfaction, engagement, or perceived immersion. This limits the ability of the system to iteratively refine its internal generation and editing strategies, thereby constraining scalability and degrading the technical quality of personalization over time.

Fourth, existing architectures for immersive content, including virtual reality experiences, generally do not provide a technical framework that converts generative AI outputs into device-specific formats while simultaneously incorporating emotion-driven adjustments.

Content is often generated in a generic video format and then simply re-encoded for various display devices, without programmatic consideration of head-mounted display capabilities, viewpoint constraints, or emotion-conditioned scene selection. As a result, the system cannot optimize resource usage and cannot provide a consistent, low-latency path from emotion input to adapted VR content output.

Accordingly, there is a need for a computer-implemented system that (i) automatically analyzes multi-modal electronic information to extract situation and emotion-related context, (ii) constructs and refines prompt sentences for a generative AI model based on that context and on user requests, (iii) performs format conversion and device-aware preparation of generated visual content, (iv) continuously recognizes and interprets user emotion and dynamically adjusts content through additional prompt sentences and editing operations, and (v) records and exploits a unified usage history to improve subsequent content generation and delivery. Addressing these issues constitutes a concrete improvement in the functioning of the computer system itself, by enhancing how it represents, generates, and adapts visual content in response to real-time user states and historical interaction patterns.

The specific processing by the specific processing unit 290 of the data processing device 12 in Application Example 2 is realized by the following means.

The present invention provides a server comprising a processor and a memory storing instructions that, when executed by the processor, cause the server to acquire electronic information from one or more information sources associated with a subject, analyze the electronic information to extract situation information and emotion-related information for a viewpoint of the subject, construct a machine-interpretable prompt sentence for instructing a generative AI model to generate visual information based on the extracted situation information and emotion-related information and based on request information received from a user, and input the constructed prompt sentence into the generative AI model; to receive visual information output from the generative AI model and perform format conversion of the visual information according to a type of a display device and a visual presentation format to generate content data in a virtual-reality format or in a non-immersive video format; to acquire facial data and voice data from a user device, estimate an emotional state of the user by applying the facial data and the voice data to an emotion analysis engine, generate an additional prompt sentence or editing instruction for editing or regenerating at least part of the content data in accordance with the estimated emotional state, and apply the additional prompt sentence or editing instruction to the generative AI model or to a content editing process so as to dynamically adjust a content of the content data; to transmit the adjusted content data to a user terminal via a communication network and cause the user terminal to provide the content data to a visual device; and to record a usage history including the prompt sentences, the estimated emotional states, the content data, and interaction information relating to the user, and to perform a learning process that updates rules for prompt construction and content editing based on the usage history so that subsequent content generation and delivery are adapted to user-specific patterns. This enables the computer system to automatically translate heterogeneous electronic information into optimized prompt sentences for a generative AI model, to generate and transform visual content into appropriate device-ready formats, and to close a real-time feedback loop in which user emotion is captured, interpreted, and fed back into the content generation and editing pipeline, thereby improving system-level responsiveness, personalization accuracy, and immersive quality while reducing manual intervention and inefficient trial-and-error in prompt design.

The term “processor” refers to one or more hardware logic units configured to execute machine-readable instructions, including a central processing unit, a graphics processing unit, a digital signal processor, or any combination thereof, capable of performing arithmetic, logic, control, and input/output operations for implementing the described functions.

The term “electronic information” refers to data represented in digital form and obtained from one or more network-accessible sources, including text data, image data, audio data, video data, and associated metadata, that describe activities, environments, or characteristics of a subject.

The term “information source” refers to a data-providing system or storage, such as a network-based publishing platform, a data server, or a database, from which electronic information associated with a subject can be acquired through an interface or communication protocol.

The term “subject” refers to an entity, such as a person or an organization, whose viewpoint, activities, or environment are to be represented or reproduced in generated visual content.

The term “situation information” refers to contextual data extracted from electronic information that describes circumstances associated with a scene, including at least one of time, location, activity, environment type, or interaction among entities.

The term “emotion information” refers to data extracted from electronic information that indicates an emotional tone or affective context associated with the subject or a scene, such as indications of happiness, excitement, calmness, sadness, or anxiety.

The term “viewpoint” refers to a perspective from which visual information is represented or generated, including a first-person perspective corresponding to the position and orientation of the subject.

The term “request information” refers to data received from a user that specifies desired characteristics of content to be generated, including at least one of a selected subject, a scenario type, a viewing mode, or a free-text request.

The term “prompt sentence” refers to a machine-interpretable textual instruction constructed for input to a generative AI model, the instruction specifying conditions, constraints, and desired properties for visual information to be generated.

The term “generative AI model” refers to a machine learning model configured to generate new data instances, such as images or videos, in response to an input including at least a prompt sentence, by learning patterns from training data and performing probabilistic or neural network-based inference.

The term “visual information” refers to data representing one or more images or video sequences, including pixel values, frame sequences, and associated attributes suitable for display on a visual output device.

The term “format conversion” refers to processing that changes at least one of encoding, resolution, aspect ratio, projection method, or container format of visual information to satisfy requirements of a display device or presentation environment.

The term “content data” refers to a data set including visual information and, optionally, associated audio information and metadata, which is prepared for delivery and playback to a user.

The term “virtual reality format” refers to a representation of content data configured for immersive presentation, including at least one of monoscopic 360-degree video, stereoscopic 360-degree video, or content mapped onto a virtual environment for head-mounted display playback.

The term “normal video format” refers to a representation of content data configured for non-immersive presentation on a conventional display, such as a single-plane video stream with a standard aspect ratio and field of view.

The term “facial information” refers to data representing at least part of a user's face captured by an image sensor, including images or video frames and derived features such as facial landmarks or expression indicators.

The term “voice information” refers to audio data representing sound produced by a user, including speech signals and associated acoustic features such as pitch, energy, and spectral characteristics.

The term “emotion analysis engine” refers to a software component or software-hardware combination configured to process user-related data, including facial information and voice information, to estimate an emotional state of the user using pattern recognition, machine learning, or rule-based techniques.

The term “emotional state” refers to an estimated affective condition of a user at a given time, represented as one or more emotion categories or as a continuous-valued vector indicating intensities of different emotions.

The term “editing” refers to processing that modifies existing content data, including selecting, trimming, reordering, or combining segments, as well as applying visual or audio effects, to change narrative structure, emphasis, or style.

The term “regenerating” refers to creating new visual information or content data, in whole or in part, by invoking the generative AI model with one or more prompt sentences, instead of or in addition to editing existing content data.

The term “user terminal” refers to an electronic apparatus operated by a user, such as a portable information processing device, a stationary computing device, or a communication device, configured to receive, store, and present content data and to send user-related data to a server.

The term “visual device” refers to a hardware output device configured to present visual information to a user, including a head-mounted display, a display-integrated computing device, or a display apparatus coupled to a user terminal.

The term “communication network” refers to a wired or wireless data communication infrastructure, including at least one of a local area network, a wide area network, or the internet, enabling data exchange between a server and one or more user terminals.

The term “usage history” refers to stored information describing past interactions between a user and the system, including data concerning prompt sentences used, estimated emotional states, content data delivered, user behavior during playback, purchase events, and feedback information.

The term “learning process” refers to computational processing that updates parameters, rules, or models used by the system, including rules for constructing prompt sentences and content editing policies, by analyzing usage history using at least one of statistical methods, machine learning algorithms, or optimization techniques.

The term “purchase history information” refers to data within the usage history that records content items or experiential products acquired by the user, including identifiers, time of purchase, and associated attributes.

The term “viewing history information” refers to data within the usage history that records how content has been consumed by the user, including playback durations, viewed content identifiers, interaction events, and timestamps.

The term “interest estimation information” refers to inferred data indicating a user's preferences or inclinations, derived from at least one of purchase history information, viewing history information, emotion-related data, or explicit selections.

The term “content editing policy” refers to a set of rules or parameter values defining how content data should be modified, including selection of scenes, timing of transitions, and application of visual or audio effects, under specified conditions such as an emotional state.

The term “personalized experiential product” refers to a content package derived from content data and associated metadata that is configured and adapted for an individual user, based on usage history, interest estimation information, and emotion-related information, to provide a customized experience.

The term “evaluation information” refers to data explicitly provided by a user to indicate a degree of satisfaction or assessment of content or an experience, including ratings, scores, or categorical evaluations.

The term “free-description information” refers to unconstrained textual or spoken input provided by a user, expressing opinions, comments, or requests regarding content, experiences, or system behavior.

The term “rules for configuring the prompt sentence” refers to machine-readable specifications, templates, or learned models that determine how elements such as situation information, emotion information, and request information are combined to form a prompt sentence for a generative AI model.

The term “rules for editing in accordance with the emotional state” refers to machine-readable specifications or learned models that define how an estimated emotional state of a user influences selection, arrangement, or modification of content segments and effects within content data.

In one embodiment, a server, one or more terminals, and one or more visual devices cooperate to implement the system. The server includes a processor, a memory, a network interface, and a non-transitory storage device. The terminal includes a processor, a memory, a user interface, at least one image sensor and audio input device, and a network interface. The visual device includes a display apparatus, such as a head-mounted display, and, in some cases, integrated sensors for head tracking.

The server executes a program stored in the memory to perform operations described below.

The program is realized, for example, as a set of modules implemented in a general-purpose operating system and executed on a multi-core central processing unit and, optionally, on a graphics processing unit. The server uses commercially available software components such as a relational database management system, an object storage system, a web server framework, a machine learning framework such as a tensor-based computation library, and a game engine or media processing tools such as a real-time rendering engine and a multimedia framework.

The server acquires electronic information from information sources associated with a subject. The server accesses network-based publishing platforms via application programming interfaces or via HTTP requests and parses responses using a text parsing library. The electronic information includes text posts, images, videos, and metadata related to activities and environments of the subject. The server stores raw electronic information and derived metadata into a database having structured tables for posts, media items, and subjects, and references corresponding binary objects stored in object storage.

The server analyzes the electronic information to extract situation information and emotion information. The server applies a natural language processing pipeline to textual content, including tokenization, part-of-speech tagging, dependency parsing, and named entity recognition. The server uses a set of pre-trained language models based on a transformer architecture to compute contextual embeddings for each sentence. From these embeddings, the server extracts entities such as locations, times, activity types, and descriptive adjectives.

The server encodes the extracted entities in a normalized schema that associates each media item with tags for time of day, place category, activity type, and coarse emotional tone.

The server analyzes image and video content using a convolutional neural network. In one embodiment, the server uses an image classification network with multiple convolutional layers, pooling layers, and fully connected layers trained to output scene categories (for example, indoor kitchen, outdoor stage), object categories (for example, food, table, microphone), and viewpoint attributes (for example, first-person-like framing, third-person framing). The server divides input video into frames at predetermined intervals and feeds the frames to the network to obtain per-frame labels. The server aggregates frame-level labels into sequence-level descriptors using a recurrent neural network or a temporal pooling strategy. The server thereby derives situation information such as “breakfast at home in the morning” or “live performance on a stage at night.”

The server generates emotion information related to the subject or the scene from the same electronic information. For text, the server applies a sentiment classifier implemented as a transformer model with an output layer that predicts probabilities over discrete emotions such as joy, sadness, excitement, or calmness. For images and videos, the server applies a separate convolutional neural network trained to infer global emotional tone based on color distribution, facial expressions of the subject, and contextual cues. The server stores these emotion estimates, along with confidence scores, in association with each analyzed segment.

The server constructs a prompt sentence for a generative AI model using the extracted situation information, the emotion information, and request information received from a user.

The server receives, from a terminal, user input specifying the subject, a desired scenario, and, optionally, a free-text description of the requested experience. The server maps the request information into an internal representation that includes normalized identifiers for scenario type, viewpoint, and stylistic preferences. The server then composes an initial prompt string using a template library that contains patterns such as “Generate a first-person video of [activity] at [location] during [time], with an emotional tone of [emotion].”

The server refines this initial prompt string using a large language model based on a transformer architecture. The server provides, as input to the language model, the initial string and structured situation and emotion features, and obtains a refined natural-language prompt that includes detailed visual cues, camera behavior, and stylistic constraints. The server records each prompt sentence together with the underlying feature vectors and user identifiers in the database for later learning.

In one example, the server constructs and refines the following prompt sentence:

“Please generate a high-quality, first-person perspective video that recreates the subject's breakfast scene. The viewer should feel as if they are the subject, sitting at a small kitchen table on a sunny morning, preparing and eating breakfast, in a warm and casual style consistent with the subject's social media photos.”

In another example, the server constructs a prompt sentence for a night scene:

“Generate a first-person image from the subject's viewpoint, looking out over a brightly lit city at night with many neon signs and reflections on wet streets, in a style similar to the subject's typical photo posts.”

The server inputs the constructed prompt sentence to a generative AI model. In one embodiment, the server uses an image-generation model based on a diffusion architecture, in which a neural network is trained to iteratively denoise samples from a noise distribution conditioned on the prompt embedding. The server encodes the prompt sentence into a latent representation using a text encoder network, and supplies that representation as conditioning input to the diffusion model. In another embodiment, for video generation, the server uses a spatio-temporal diffusion model or a transformer-based video generator that treats time as an additional dimension and performs attention across space and time.

The server specifies generation parameters such as target resolution, duration, frame rate, and random seed. The generative AI model outputs an image or video sequence as numerical arrays representing pixel intensities, which the server writes to binary media files. The server validates the generated content by checking basic statistics such as color distribution and motion smoothness and may compute an aesthetic score using an additional neural network.

The server discards samples that fall below a threshold and, if necessary, regenerates content with modified parameters.

The server converts the generated visual information into a content data format suitable for a particular visual device. The server uses a multimedia toolkit to transcode the video into a compressed format with specific codecs and bitrates. For immersive presentation, the server performs projection mapping into an equirectangular or cube-map format and encapsulates the video as a 360-degree asset. When a game engine is used, the server maps the video as a texture onto a virtual sphere surrounding a virtual camera and exports runtime assets that can be streamed or downloaded to a terminal.

The server stores content data, along with descriptors indicating whether the format is virtual reality or normal video, in a media catalog. The server associates each content item with the prompt sentence, the underlying feature vectors, and supported device types. Such structured association between generation instructions and output media enables later analysis and learning regarding which prompt constructions lead to effective content for particular devices.

The terminal acquires user-related data during consumption of the content. The terminal receives content data from the server, decodes it, and outputs video and audio to a visual device. The terminal concurrently captures facial information and voice information of the user using a built-in camera and microphone. The terminal processes the captured frames by applying face detection and landmark detection to obtain feature vectors that encode facial expression attributes. The terminal computes audio features such as pitch contour, spectral envelope, and energy distribution from the user's voice segments.

The terminal transmits these feature vectors to the server, along with timestamps relative to the content playback. The server applies an emotion analysis engine implemented as a neural network that maps the facial and audio features into an emotional state representation. In one embodiment, the server uses a multi-modal network with separate sub-networks for visual and audio features and a fusion layer that combines the outputs into a joint hidden representation. A final classification layer outputs probabilities for different emotional categories and continuous scores representing intensity. The server stores each estimated emotional state in an emotion event table, indexed by content identifier, user identifier, and playback time.

The server generates an additional prompt sentence or editing instruction using the estimated emotional state. When the emotional state indicates high excitement, the server constructs a new prompt sentence that requests generation of highlight scenes. For example, the server may construct:

“The user is currently highly excited. Generate an additional first-person segment showing the most energetic moment of the performance, with the audience cheering loudly and dynamic camera movement from the subject's viewpoint.”

When the emotional state indicates anxiety or fatigue, the server constructs a prompt sentence emphasizing calm content, such as:

“The user appears anxious. Generate a calming first-person scene where the subject is quietly reading at home with soft, warm lighting and slow camera motion to soothe the viewer.”

The server feeds these additional prompt sentences into the generative AI model to obtain new content segments or uses them to configure editing rules for existing content. An editing module selects candidate segments from a pool of generated or pre-existing scenes, reorders them, and adjusts their duration and transitions. The editing module uses constraint satisfaction or dynamic programming to assemble a sequence that reacts to the emotional state while respecting overall narrative constraints. The server updates a manifest file or playlist that indicates which segments the terminal should request next.

The terminal, upon receiving updates to the manifest, requests the new or rearranged segments and merges them into ongoing playback or prepares them for future sessions. The user therefore perceives an experience that is adjusted in real time or between sessions, based on their emotional responses.

The server records a usage history that includes prompt sentences, estimated emotional states, delivered content items, playback behavior, purchase behavior, and explicit evaluation information. The server stores this usage history in structured tables designed to support efficient retrieval and training. For example, a prompt table includes tokenized and embedded representations of each prompt sentence, and an associated outcome table contains metrics such as watch time, rewatch frequency, and user rating.

The server performs a learning process on the usage history to update rules and models for prompt construction and content editing. In one embodiment, the server trains a neural network that takes as input user features, situation information, and prior emotional responses, and outputs parameters that modify templates and word choice in prompt sentences. The server optimizes this network using a loss function that combines prediction error for user satisfaction metrics and regularization terms to maintain linguistic fluency.

Gradient-based optimization methods such as stochastic gradient descent with adaptive learning rates adjust weights in the network.

The server similarly trains models that map emotional state sequences to editing policies. The server uses reinforcement learning or sequence modeling techniques, where the state includes recent emotional estimates and content features and the actions correspond to selecting or skipping candidate segments. A reward signal is defined based on subsequent viewing time and positive feedback. Using these methods, the server improves the efficiency and effectiveness of its content adaptation over time.

By implementing these specific data structures, model architectures, and learning procedures, the server does more than automate manual content selection. The server improves computer technology in several ways. The server reduces the need for computationally expensive exhaustive search over prompt patterns by learning mappings from feature vectors to high-performing prompt sentences, thereby reducing processing time and resource usage. The server reduces storage and communication overhead by selecting and generating only those content segments that are likely to be effective for a particular user emotional trajectory, rather than transmitting large, generic assets. The server improves accuracy of emotion-conditioned generation by using multi-modal feature representations and trained neural networks to estimate emotional states and to select or generate content aligned with fine-grained user responses.

The server and terminal use non-conventional data flows and control loops that are not simply human procedures performed on a computer. The system integrates real-time sensor data, high-dimensional emotion feature vectors, content generation parameters, and device capabilities into a unified computational pipeline. This pipeline creates feedback between user emotion signals and generative AI outputs at run time, which cannot be replicated by manual editing or static recommendation approaches. The specific combination of multi-modal analysis, prompt sentence optimization, generative model invocation, device-aware format conversion, and adaptive editing, tied to a persistent learning process, yields improved throughput, reduced latency in content adaptation, and more stable quality of immersive experiences.

In alternative embodiments, the server may employ different model types. Instead of a diffusion-based generator, the server may use a generative adversarial network with a generator and discriminator, where the generator produces candidate frames conditioned on prompt embeddings and the discriminator evaluates realism. Instead of a transformer-based prompt refiner, the server may use a recurrent neural network or a rule-based system augmented with learned weights. The emotion analysis engine may be implemented with a support vector machine or a gradient boosting model on top of hand-crafted features instead of deep feature extractors. The overall system architecture remains consistent, in that the server still constructs prompt sentences from structured situation and emotion information, generates content through a generative AI model, adjusts content based on estimated emotional states, converts content into formats suitable for visual devices, and updates its internal rules using recorded usage history.

In further embodiments, the terminal may perform part of the emotion estimation locally to reduce communication load. The terminal may run a lightweight neural network that maps raw facial images to intermediate emotion feature vectors, and send only compressed features to the server. This reduces bandwidth requirements and improves privacy while maintaining the ability of the server to perform high-level adaptation. The server and terminal thus cooperate to distribute computation in a way that optimizes both system responsiveness and network utilization.

The user interacts with the system by selecting subjects and scenarios, providing free-text descriptions, viewing or experiencing generated content through the visual device, and providing explicit feedback. The user does not need to manually construct prompt sentences or understand internal model operations. The server handles the complexity of analyzing electronic information, composing optimized prompt sentences, invoking generative AI models, and adapting content in response to emotional states. As a result, the described embodiments enable a person skilled in the art to implement the invention using standard computing hardware and software frameworks, while achieving technical improvements in content generation efficiency, precision of personalization, and responsiveness of immersive experiences.

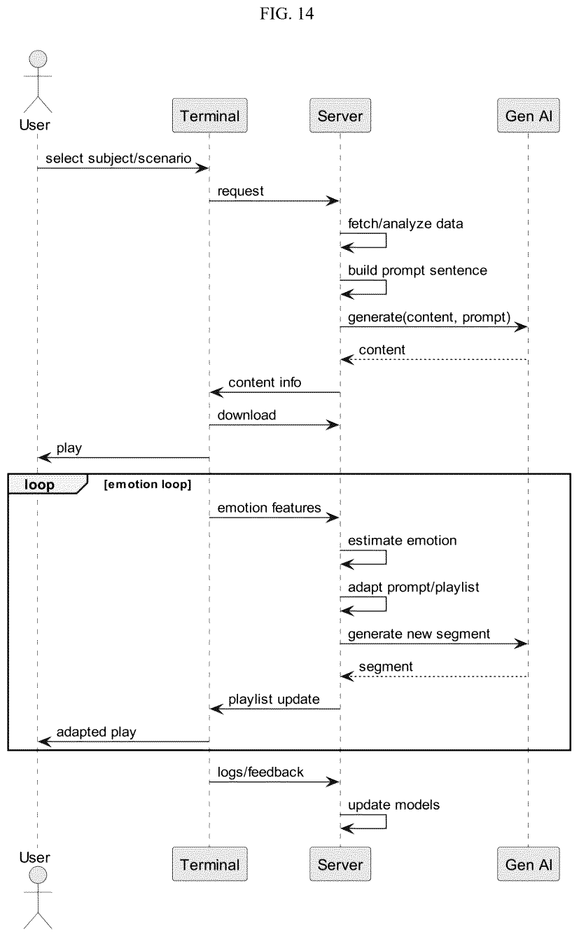

The following describes the processing flow using FIG. 14.

### Step 1

The user operates the terminal to select a subject and a desired scenario and to input an optional free-text request.

The input is selection data including at least a subject identifier, a scenario type, and an optional natural-language request.

The terminal converts the selection data into a structured request message, for example by assigning identifiers to the selected subject and scenario, attaching the free-text string, and adding device capability information (display type, VR support), and then transmits the request message to the server via a communication network.

The output is a request message received by the server that initiates a content-generation task.

### Step 2

The server receives the request message from the terminal and validates the contents.

The input is the structured request message containing the subject identifier, scenario type, optional free-text request, and device information.

The server checks that the identifiers exist in a subject database, verifies that the scenario is supported, and normalizes the free-text request by removing unsupported characters and detecting language. The server then creates a new generation-task record in a task table, assigning a unique task identifier and associating it with the user identifier and request parameters.

The output is a registered content-generation task with a corresponding task identifier stored in the server database.

### Step 3

The server acquires electronic information associated with the selected subject from one or more information sources.

The input is the subject identifier and scenario type stored in the generation-task record, along with stored account information for external platforms.

The server calls external APIs or executes HTTP requests to obtain text posts, images, videos, and metadata related to the subject. The server filters the retrieved data based on the scenario type by matching tags, timestamps, and textual keywords. The server stores the filtered electronic information in an electronic-information table and object storage, linking each item to the task identifier.

The output is a set of electronic-information records and associated media objects tagged for the current task.

### Step 4

The server analyzes the textual portion of the electronic information to extract situation information and emotion information.

The input is a collection of text strings (captions, descriptions, comments) associated with the filtered electronic information.

The server applies a natural language processing pipeline, including tokenization, parsing, and named entity recognition, to identify entities such as time of day, location, activity, and descriptive terms. The server then applies an emotion classifier to the text to estimate emotional tone categories with probability scores. The server aggregates the extracted entities and emotion scores for each text item into a situation-and-emotion record, normalizing them into a fixed schema (for example, “morning,” “indoor,” “meal,” “happy”).

The output is a structured set of situation information and emotion information stored in association with the electronic information and task identifier.

### Step 5

The server analyzes the image and video portion of the electronic information to extract additional situation information and viewpoint attributes.

The input is a collection of images and sampled video frames associated with the task.

The server passes each image or frame through a convolutional neural network to detect scene categories, object categories, and viewpoint-related features such as camera height and framing pattern. The server performs temporal aggregation over sequences of frames to determine predominant activities and environments. The server merges this visual analysis with the textual analysis from Step 4 by aligning records with common media identifiers, and resolves conflicts by applying predefined priority rules.

The output is an enriched set of situation information that includes both textual and visual cues, and updated emotion information if visual tone differs significantly from textual tone.

### Step 6

The server generates an internal representation of the target scene and constructs an initial prompt sentence.

The input is the enriched situation and emotion information, the user's request information from the task record, and predefined prompt templates.

The server selects a scenario template based on the scenario type and device capabilities, fills template slots with extracted attributes (time, location, activity, emotion), and incorporates user-specified constraints from the free-text request by mapping key phrases to internal attributes. The server then concatenates sentence fragments to form an initial prompt sentence that specifies viewpoint, environment, emotional tone, and style.

The output is an initial prompt sentence and a structured scene representation stored with the task record.

### Step 7

The server refines the initial prompt sentence using a language model to improve specificity and generative suitability.

The input is the initial prompt sentence, the structured scene representation, and optional historical data about successful prompts for the same user or subject.

The server encodes the initial prompt and scene features and provides them to a language model that outputs a refined prompt sentence with additional descriptive details such as camera movement, lighting conditions, and interactions. The server may also apply rule-based post-processing to ensure the presence of required technical constraints such as “first-person perspective” or “VR-friendly view.”

The output is a refined prompt sentence stored in the task record and ready to be sent to the generative AI model.

### Step 8

The server invokes the generative AI model to generate visual information based on the refined prompt sentence.

The input is the refined prompt sentence and generation parameters such as resolution, duration, frame rate, and random seed, determined according to device information and scenario type.

The server encodes the prompt sentence into a numerical embedding using a text encoder, passes the embedding and generation parameters to the generative AI model, and initiates a generation process. The generative AI model performs iterative numerical operations, such as diffusion denoising steps or adversarial updates, to produce pixel arrays representing images or frames. The server receives the generated pixel data and encodes it into a standard image or video format.

The output is raw visual information in file form (for example, an image file or video file) associated with the task identifier.

### Step 9

The server validates and scores the generated visual information to ensure quality and consistency.

The input is the generated image or video file and associated generation metadata.

The server computes basic statistics such as luminance histogram, motion smoothness metrics, and detection scores for artifacts. The server optionally passes sampled frames through a quality assessment neural network that outputs an aesthetic and realism score. The server compares these scores to pre-set thresholds; if a file fails, the server logs the failure, adjusts generation parameters (for example, modifies random seed or simplifies the prompt), and repeats Step 8. If multiple candidate outputs exist, the server selects the candidate with the highest combined quality score.

The output is a validated and selected visual information file approved for downstream processing.

### Step 10

The server converts the validated visual information into content data adapted to the type of visual device.

The input is the validated visual file and device information from the user's request.

The server determines whether the terminal uses a head-mounted display or a standard screen, selects appropriate codecs and resolutions, and, for VR devices, maps the video to an equirectangular or spherical projection. The server uses multimedia processing software to perform transcoding and, if required, to embed metadata indicating 360-degree format or stereoscopic parameters. The server then encapsulates the processed media into a content data package and registers its location and attributes in a content catalog.

The output is content data optimized for the target device, identified by a content identifier linked to the task.

### Step 11

The server transmits content metadata and download information to the terminal.

The input is the content identifier, content data location, and descriptive metadata (format, duration, recommended playback mode).

The server constructs a response message containing a secure download URL, content attributes, and playback instructions. The server sends this response through a content API endpoint to the terminal that issued the original request. The server updates the task record status to indicate that initial content is ready for consumption.

The output is a response message received by the terminal that enables download or streaming of the content data.

### Step 12

The terminal downloads and prepares the content data for playback.

The input is the response message including the download URL and content attributes.

The terminal initiates an HTTP or streaming request to retrieve the content data from the server or media storage. The terminal writes the incoming data to local storage, verifies data integrity using checksums if provided, and configures a media player or VR player instance according to the content attributes (for example, enabling 360-degree mode, setting field of view). The terminal associates the content identifier with local file paths and player settings.

The output is a locally accessible, configured content item ready for playback on the terminal and visual device.

### Step 13

The user consumes the content via the terminal and visual device.

The input is the prepared content item and playback configuration on the terminal.

The user initiates playback through the user interface. The terminal decodes the content data, sends video frames to the visual device display, and outputs audio through speakers or headphones. For a head-mounted display, the visual device uses its sensors to update the displayed portion of the 360-degree image according to head orientation, while the terminal continues to supply frames according to the content timeline. The user may issue control commands such as pause, seek, or scenario change, which the terminal captures as interaction events.

The output is an executed playback session and a log of interaction events and playback statistics on the terminal.

### Step 14

The terminal captures user emotion-related signals during playback and forwards them to the server.

The input is live camera frames depicting the user's face, microphone audio capturing the user's voice, and the current playback time and content identifier.

The terminal applies on-device preprocessing, such as face detection and cropping, and extracts basic facial landmarks and audio features. The terminal packages the extracted features with timestamps and the content identifier into an emotion-feature message to reduce data volume compared to raw media. The terminal sends this message to the server over the communication network.

The output is a stream of emotion-feature messages received by the server, each aligned with specific points in the playback.

### Step 15

The server estimates the user's emotional state based on the received emotion-feature messages.

The input is the set of emotion-feature messages containing facial feature vectors, audio feature vectors, timestamps, and content identifier.

The server feeds the feature vectors into an emotion analysis engine, which executes a multi-layer neural network or other classifier to compute probabilities for each emotion category and continuous intensity scores. The server may apply temporal smoothing by aggregating outputs over a sliding window to reduce noise. The server stores each estimated emotional state entry in an emotion-event table, indexed by user identifier, content identifier, and playback time.

The output is a time series of estimated emotional states associated with the current playback session.

### Step 16

The server determines whether to adjust content based on the estimated emotional states and constructs additional prompt sentences or editing instructions.

The input is the time series of estimated emotional states, the current content sequence, and usage history for the user.

The server evaluates the emotional state sequence against predefined or learned rules, for example detecting sustained high excitement, drops in engagement, or signs of anxiety. When adjustment conditions are met, the server selects a desired adaptation type, such as increasing highlight segments or inserting calming scenes. The server composes an additional prompt sentence that encodes the desired adaptation using the same template and refinement pipeline as in earlier steps, or generates an editing instruction that identifies specific types of segments to include or exclude.

The output is one or more adaptation directives in the form of prompt sentences or editing instructions.

### Step 17

The server generates or selects new content segments according to the adaptation directives.

The input is the adaptation directives and the current pool of generated or accessible content segments.

If a directive is a prompt sentence, the server invokes the generative AI model again to create new visual information, following Steps 8 to 10 for the new segments. If a directive is an editing instruction, the server searches the existing segment pool, scores candidate segments against criteria defined in the instruction (for example, excitement level, calmness), and selects a subset that best fits the user's current emotional state. The server then updates a content manifest or playlist, inserting references to the new or alternative segments at appropriate positions in the sequence.

The output is an updated manifest or playlist specifying a personalized sequence of content segments for the user.

### Step 18

The terminal receives manifest or playlist updates and adjusts upcoming playback accordingly.

The input is the updated manifest or playlist transmitted from the server, including identifiers and locations for newly generated or selected segments.

The terminal parses the updated manifest, determines which segments must be requested next, and downloads or buffers these segments before they are needed in playback. The terminal schedules playback transitions so that when the current segment ends or a predefined switch-point occurs, the player seamlessly transitions to the new segment. The terminal continues to supply frames to the visual device according to the updated sequence.

The output is a dynamically adapted playback experience that reflects the user's emotional responses.

### Step 19

The server records a comprehensive usage history after or during the session.

The input is logs from the terminal (playback events, interaction events), records of generated and delivered content, prompt sentences used, emotional state sequences, and any explicit user feedback received.

The server merges these inputs into a unified data structure, populating tables for prompt usage, content outcome metrics, emotional trajectories, and feedback ratings. The server normalizes timestamps and identifiers so that each usage record links a specific prompt sentence and content item with resulting user behavior and emotional responses.

The output is an updated usage-history database ready for learning processes.

### Step 20

The server performs learning processes on the usage history to improve future prompt construction and content editing policies.

The input is the usage-history database containing past prompt sentences, content attributes, emotional responses, and satisfaction indicators.

The server samples training examples from the usage history and trains or updates models that map from situation information, user profile, and prior outcomes to optimal prompt configurations and editing decisions. The server computes loss functions that measure differences between predicted and observed satisfaction or engagement and applies optimization algorithms to adjust model parameters. The server then stores updated model parameters and rule sets, which will be used in future executions of Steps 6, 7, 16, and 17.

The output is an improved set of models and rules that enable the server to generate more effective prompt sentences, select more appropriate content segments, and adapt content more efficiently for subsequent users and sessions.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

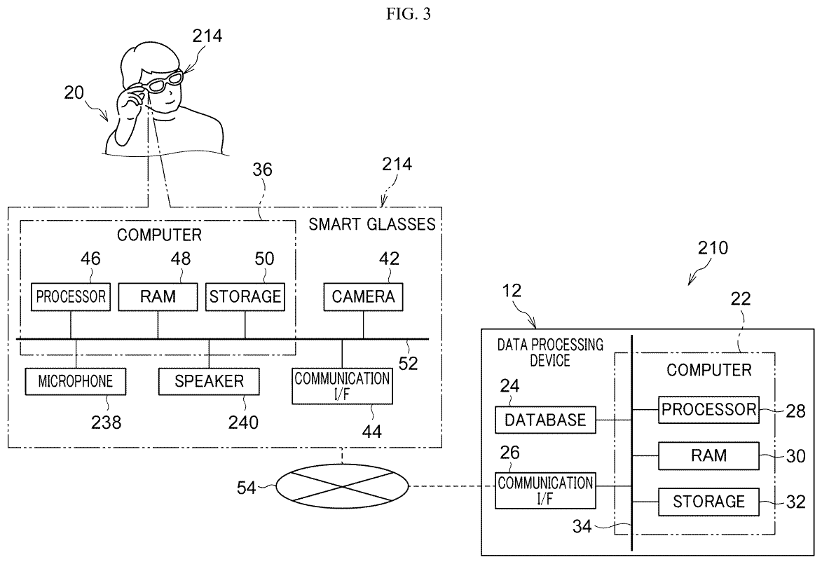

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

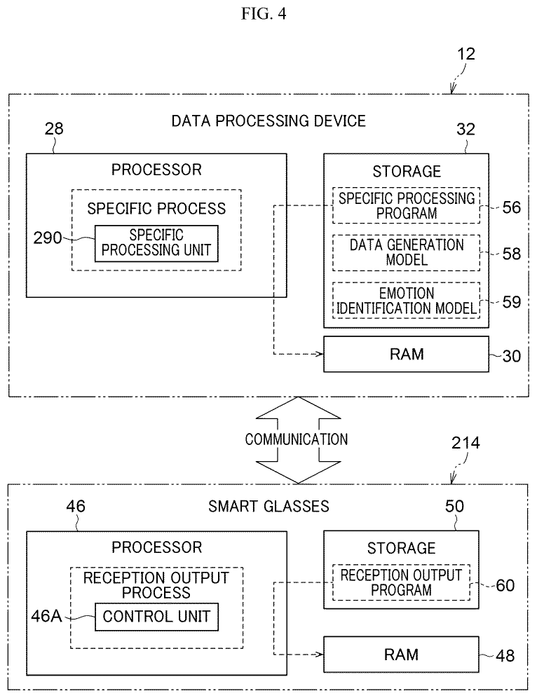

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

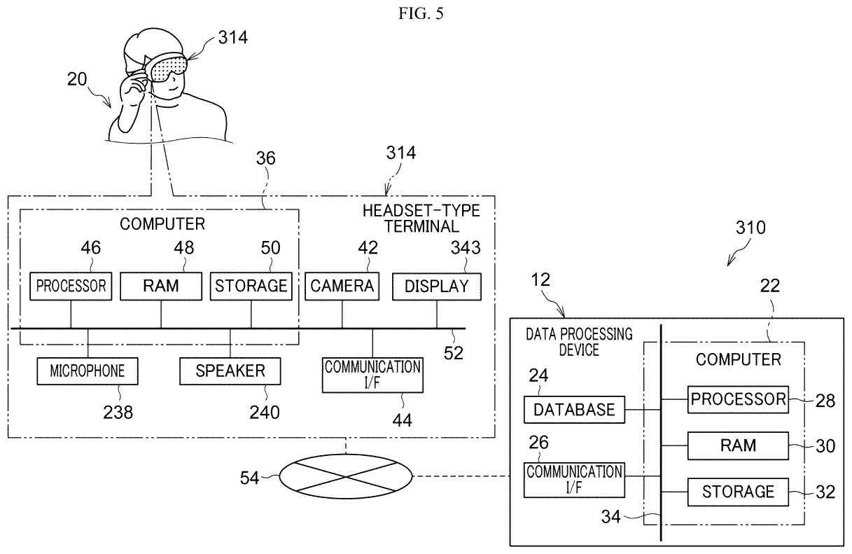

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

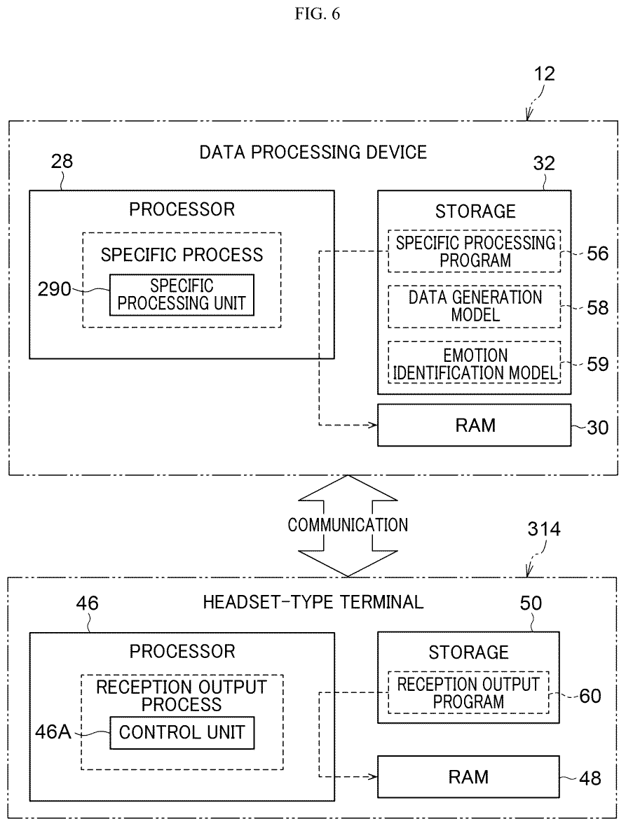

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

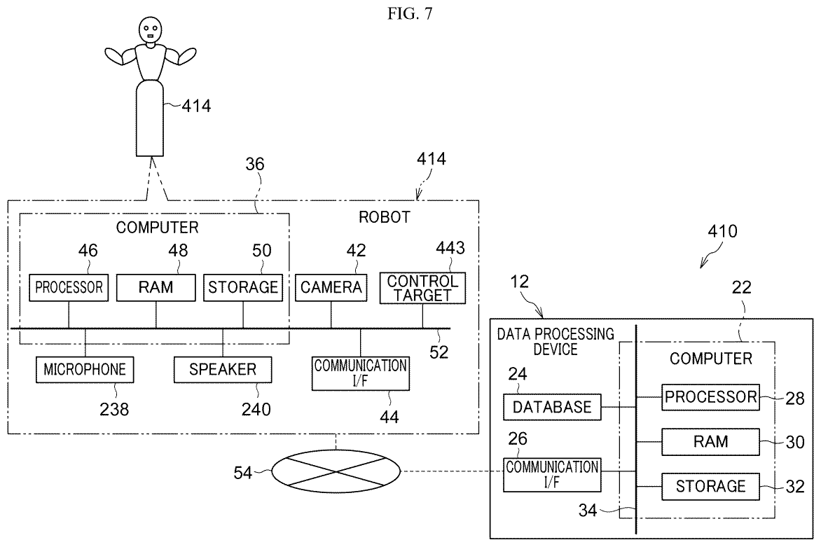

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

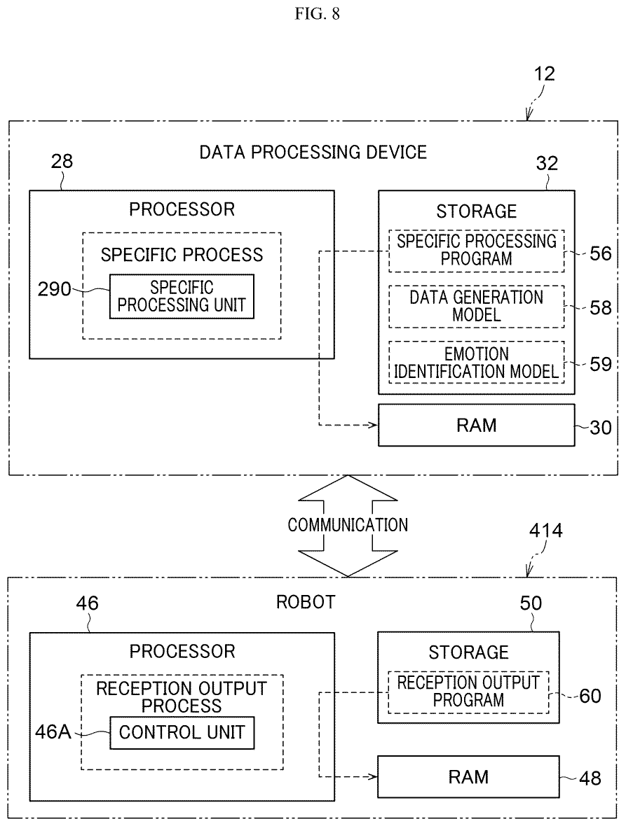

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

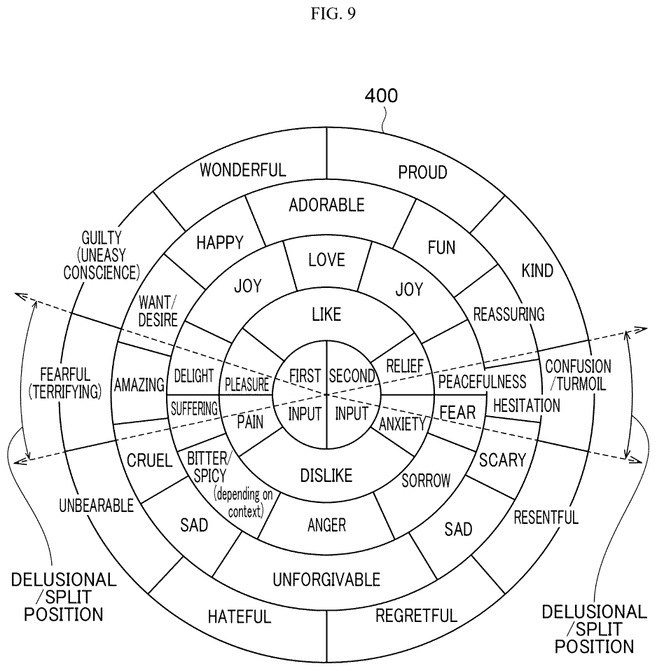

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

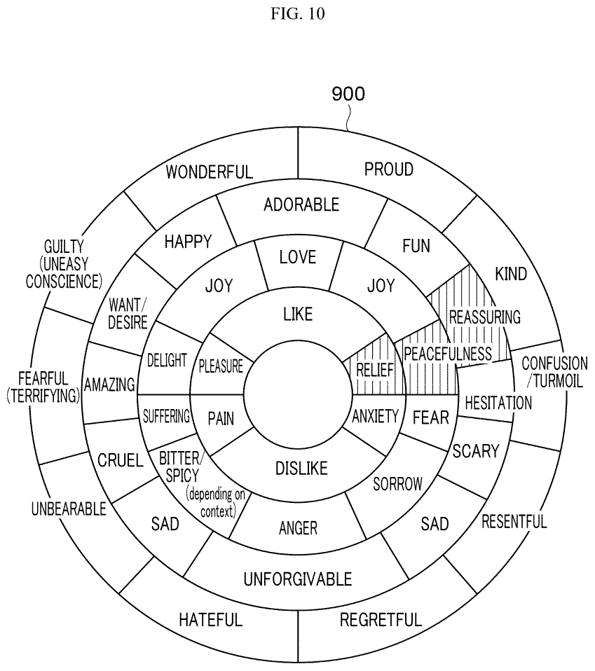

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, from a user terminal, input information regarding an information providing entity, and, based on the input information, identify information sources related to the information providing entity and acquire, from the information sources, text data and image data or video data regarding the information providing entity,
analyze the acquired text data by using natural language processing, and analyze the acquired image data or video data by using image recognition processing, to extract viewpoint feature data including position information, object information, capture condition information, and expression style information that characterize a viewpoint of the information providing entity, and generate viewpoint profile data by integrating the viewpoint feature data,
automatically generate a prompt sentence configured to instruct a generative AI model to generate visual information that imitates the viewpoint of the information providing entity, based on the viewpoint profile data and experience request information received from the user terminal,
input the prompt sentence into the generative AI model and cause the generative AI model, by numerical computation processing, to generate content data including image data or video data that imitates the viewpoint of the information providing entity,
perform format conversion processing or quality adjustment processing on the generated content data and register the processed content data as content data of an experience product, and
receive, from the user terminal, a purchase request for the content data registered as the experience product, and, in response to the purchase request, deliver the content data to the user terminal.

### Supplementary 2

The system according to supplementary 1,
wherein the processor is configured to analyze behavior history data and attribute data of a user, associate the viewpoint profile data with the content data registered as the experience product, generate product proposal data by selecting, for each user, experience products having high relevance, and output the product proposal data to the user terminal.

### Supplementary 3

The system according to supplementary 1,
wherein the processor is configured to store, as feedback data, evaluation information or comment information received from the user terminal after viewing of the content data, update the viewpoint profile data or generation conditions of the prompt sentence by using the feedback data, and reflect updated conditions in a subsequent content generation process performed by the generative AI model.

### Application Example 1

### Supplementary 1

A system comprising a processor,
wherein the processor is configured to
acquire, from a user terminal, identification information of a target viewpoint subject and information source identification information, collect over a network text data, image data, and video data related to the target viewpoint subject from one or more information sources, perform natural language processing on the collected data to structure the collected data, and store the structured data as viewpoint-reproduction context data, and
generate, on the basis of the viewpoint-reproduction context data and experience request conditions acquired from a user, a prompt sentence that instructs a generative AI model to generate visual information representing imagery from a viewpoint of the target viewpoint subject, input the prompt sentence into the generative AI model, and thereby cause the generative AI model to generate image data or video data viewed from the viewpoint of the target viewpoint subject, and
set, according to the experience request conditions and the viewpoint-reproduction context data, a model type, a resolution, a frame rate, and inference parameters used in inference processing of the generative AI model, perform image quality correction processing and encoding processing on the generated image data or video data, and generate content data for streaming distribution, and
divide the content data for streaming distribution into segment data and manifest data, generate streams of a plurality of bitrates, notify the user terminal of playback information indicating a location of the manifest data, and sequentially distribute the segment data to the user terminal, and
update, on the basis of emotion state information, preference information, or evaluation information acquired from the user terminal, configuration rules of the prompt sentence and the inference parameters of the generative AI model, and adjust contents of viewpoint content from the viewpoint of the target viewpoint subject to be generated subsequently, and cause the user terminal to decode the content data for streaming distribution and present, on a visual presentation device, video from the viewpoint of the target viewpoint subject, thereby enabling the user to re-experience an experience of the target viewpoint subject.

### Supplementary 2

The system according to supplementary 1,
wherein the processor is configured to
analyze past content viewing history information, purchase history information, and interest information of the user, extract candidate re-experience products related to the target viewpoint subject, expand the prompt sentence at a time of generation of the prompt sentence so as to include scenes, situations, or objects corresponding to the candidate re-experience products, and present the candidate re-experience products in association with content generated on the basis of the expanded prompt sentence to the user terminal.

### Supplementary 3

The system according to supplementary 1,
wherein the processor is configured to
collect evaluation information, improvement request information, or preference change information regarding generated content from the user, adjust, on the basis of the collected information, weighting of viewpoint expressions, scene expressions, or emotion expressions in the prompt sentence, and negative prompt elements and inference parameters for the generative AI model, and generate, by using an adjusted prompt sentence and adjusted inference parameters, subsequent content from the viewpoint of the target viewpoint subject.

### Example 2

### Supplementary 1

A system comprising a processor,
wherein the processor is configured to
automatically acquire, from an information source related to a subject provider, a data set including visual information and character information and store the data set in a storage region,
analyze still image information and moving image information included in the data set by executing image analysis processing, and analyze character string information included in the data set by executing natural language analysis processing, thereby extracting feature information related to a situation, a place, a time zone, and an action content of daily behavior of the subject provider,
generate a prompt sentence based on the feature information, the prompt sentence describing conditions including a first-person viewpoint from the subject provider, a scene, a time zone, an action content, and an atmosphere, and input the prompt sentence to a generative AI model to cause the generative AI model to generate visual data reproducing the viewpoint of the subject provider,
recognize an emotional state of a user, and adjust content of the prompt sentence or generation conditions of the generative AI model according to the emotional state to change content of content to be generated, and
manage the generated visual data as an experience product, present information related to the experience product to a user terminal by an online providing function, and, in response to a purchase request or a use request, distribute the visual data to the user terminal.

### Supplementary 2

The system according to supplementary 1,
wherein the processor is configured to analyze purchase history information and preference information of the user, and perform individualized product recommendation by selecting and presenting, from among a plurality of experience products generated in the system, an experience product suitable for the user.

### Supplementary 3

The system according to supplementary 1,
wherein the processor is configured to aggregate and analyze evaluation information and use history information acquired from the user, and, based on an analysis result, update generation rules of the prompt sentence or input conditions to the generative AI model to improve content of content to be generated subsequently.

### Application Example 2

### Supplementary 1

A system comprising a processor,
wherein the processor is configured to
acquire electronic information from information sources related to a subject and analyze the electronic information to extract situation information and emotion information in a viewpoint of the subject,
construct a prompt sentence for instructing a generative AI model to generate visual information, based on the extracted situation information and emotion information and request information acquired from a user, and input the prompt sentence to the generative AI model,
perform format conversion on visual information output from the generative AI model in accordance with a type of a display device and a visual presentation format, and generate content data in a virtual reality format or in a normal video format,
acquire facial information and voice information of the user and estimate an emotional state of the user by using an emotion analysis engine, and generate an additional prompt sentence for editing or regenerating the content data in accordance with the emotional state and apply the additional prompt sentence to the generative AI model or to editing processing so as to dynamically adjust a content of the content data,
deliver the adjusted content data to a user terminal via a communication network and cause the user terminal to provide the content data to a visual device, and
record a usage history regarding the prompt sentence, the emotional state, and the content data, and perform a learning process that reflects the usage history on a subsequent configuration of the prompt sentence and on subsequent content generation conditions.

### Supplementary 2

The system according to supplementary 1,
wherein the processor is configured to
treat the usage history as including purchase history information of the user, viewing history information of the user, and interest estimation information of the user, and analyze the purchase history information, the viewing history information, and the interest estimation information to determine, for each user, a prompt sentence and a content editing policy, and generate control information for proposing a personalized experiential product.

### Supplementary 3

The system according to supplementary 1,
wherein the processor is configured to
store evaluation information and free-description information acquired from the user in association with the usage history, and update rules for configuring the prompt sentence and rules for editing in accordance with the emotional state based on the evaluation information and the free-description information, so as to control subsequent content generation and provision to enhance immersion and a sense of unity for the user.

What is claimed is:

1. A system comprising:
circuitry configured to:
receive, via a communication interface coupled to a packet-switched network, input data identifying a content-providing entity, and acquire, from one or more data sources via the communication interface, text data and at least one of image data or video data associated with the content-providing entity;
analyze the text data using a natural language processing algorithm, and analyze the at least one of image data or video data using an image recognition algorithm, to extract viewpoint feature data comprising position data, object data, capture condition data, and expression style data characterizing a perspective of the content-providing entity;
generate viewpoint profile data by integrating the viewpoint feature data in a machine-readable structure, and store the viewpoint profile data in a storage device;
automatically generate a prompt sentence configured to instruct a generative neural network model to generate visual content data imitating the perspective of the content-providing entity, based on the viewpoint profile data and experience request data received from a terminal device;
input the prompt sentence to the generative neural network model and receive visual content data comprising at least one of image data or video data from the generative neural network model;
apply format conversion processing or quality adjustment processing to the visual content data and store the processed visual content data in the storage device; and
receive a user state parameter derived from interaction data of a user of the terminal device, and adjust at least one of content selection criteria or generation conditions of the prompt sentence based on the user state parameter prior to a subsequent content generation cycle.

2. The system according to claim 1, wherein the circuitry is configured to apply the natural language processing algorithm to the text data to extract entity-attribute pairs and style descriptors, and apply the image recognition algorithm to a frame sequence of the at least one of image data or video data to extract keypoint data, object bounding boxes, and scene attribute data, and incorporate the extracted entity-attribute pairs, style descriptors, keypoint data, object bounding boxes, and scene attribute data into the viewpoint feature data.

3. The system according to claim 2, wherein the circuitry is configured to apply a convolutional neural network to frames of the at least one of image data or video data to generate spatial feature maps, extract position data and capture condition data from the spatial feature maps, and store the extracted position data and capture condition data as components of the viewpoint profile data.

4. The system according to claim 3, wherein the circuitry is configured to generate the prompt sentence by selecting a generation template based on the experience request data, substituting the viewpoint profile data into the generation template to produce a viewpoint-conditioned prompt sentence, and appending output format constraints specifying image dimensions and style parameters.

5. The system according to claim 4, wherein the circuitry is configured to receive feedback data from the terminal device comprising at least one of evaluation data or annotation data associated with the visual content data, and update at least one of the viewpoint profile data or generation conditions of the prompt sentence based on the feedback data to refine subsequent visual content generation.

6. The system according to claim 5, wherein the circuitry is configured to apply an incremental update algorithm to the viewpoint profile data by computing a weighted combination of the existing viewpoint profile data and feature data derived from the feedback data, and store the updated viewpoint profile data in the storage device.

7. The system according to claim 1, wherein the circuitry is configured to apply an emotion recognition algorithm to user interaction data received from the terminal device to generate the user state parameter, classify the user state parameter into one of a plurality of emotional state categories, and select an adjusted generation condition for the generative neural network model based on the classified emotional state category.

8. The system according to claim 7, wherein the circuitry is configured to adjust a style parameter, a color palette parameter, or a perspective parameter of the prompt sentence based on the user state parameter, input the adjusted prompt sentence to the generative neural network model, and transmit visual content data generated under the adjusted parameters to the terminal device.

9. The system according to claim 8, wherein the circuitry is configured to detect a change in the user state parameter exceeding a state-change threshold between consecutive content generation cycles, regenerate the prompt sentence incorporating the updated user state parameter, and supply the regenerated prompt sentence to the generative neural network model.

10. The system according to claim 1, wherein the circuitry is configured to analyze behavior history data and attribute data of a plurality of users in association with the viewpoint profile data and the stored visual content data, compute a relevance score between each of a plurality of stored visual content items and each user based on the behavior history data and attribute data, and generate content proposal data identifying visual content items having highest relevance scores for each user.

11. The system according to claim 10, wherein the circuitry is configured to transmit the content proposal data to the terminal device as a ranked list of visual content items, receive a selection input from the terminal device indicating a selected visual content item, and transmit the selected visual content item to the terminal device.

12. The system according to claim 1, wherein the circuitry is configured to identify a plurality of data sources associated with the content-providing entity based on the input data, apply a data-source ranking algorithm to rank the plurality of data sources by relevance, and acquire the text data and the at least one of image data or video data from data sources ranked above a relevance threshold.

13. The system according to claim 12, wherein the circuitry is configured to apply a deduplication algorithm to the acquired text data and at least one of image data or video data to remove redundant content, and generate the viewpoint feature data from the deduplicated content.

14. The system according to claim 1, wherein the circuitry is configured to generate a plurality of candidate prompt sentences each incorporating different subsets of the viewpoint profile data, input each candidate prompt sentence to the generative neural network model to generate a plurality of candidate visual content items, and select a final visual content item from the plurality of candidate visual content items based on a quality metric.

15. The system according to claim 14, wherein the circuitry is configured to compute the quality metric by applying a content-consistency scoring algorithm that measures alignment between the visual content data and the viewpoint profile data, and select the candidate visual content item having the highest content-consistency score as the final visual content item.

16. The system according to claim 1, wherein the circuitry is configured to generate a multi-modal prompt sentence incorporating text data derived from the viewpoint profile data together with a reference image selected from the stored visual content data, and input the multi-modal prompt sentence to the generative neural network model to generate visual content data with higher viewpoint consistency.

17. The system according to claim 1, wherein the circuitry is configured to store, in the storage device, a history of prompt sentences and visual content data generated across a plurality of content generation cycles, and supply at least a portion of the stored history as context data in subsequent prompt sentences to improve temporal consistency of generated visual content data.

18. A system comprising:
circuitry configured to:
receive, via a communication interface coupled to a packet-switched network, input data identifying a content-providing entity, and acquire text data and at least one of image data or video data associated with the content-providing entity from one or more data sources;
apply a natural language processing algorithm to the text data and an image recognition algorithm to the at least one of image data or video data to extract viewpoint feature data comprising position data, object data, capture condition data, and expression style data;
generate viewpoint profile data by integrating the viewpoint feature data and store the viewpoint profile data in a storage device;
generate a prompt sentence based on the viewpoint profile data and experience request data received from a terminal device, input the prompt sentence to a generative neural network model, and receive visual content data from the generative neural network model; and
apply a quality adjustment process to the visual content data, store the processed visual content data in the storage device, and transmit the processed visual content data to the terminal device.

19. The system according to claim 18, wherein the circuitry is configured to receive feedback data from the terminal device, update the viewpoint profile data based on the feedback data, and regenerate the prompt sentence incorporating the updated viewpoint profile data to refine subsequent visual content generation.

20. A method performed by circuitry, the method comprising:
receiving, via a communication interface coupled to a packet-switched network, input data identifying a content-providing entity, and acquiring, from one or more data sources via the communication interface, text data and at least one of image data or video data associated with the content-providing entity;
analyzing the text data using a natural language processing algorithm, and analyzing the at least one of image data or video data using an image recognition algorithm, to extract viewpoint feature data comprising position data, object data, capture condition data, and expression style data characterizing a perspective of the content-providing entity;
generating viewpoint profile data by integrating the viewpoint feature data in a machine-readable structure, and storing the viewpoint profile data in a storage device;
automatically generating a prompt sentence configured to instruct a generative neural network model to generate visual content data imitating the perspective of the content-providing entity, based on the viewpoint profile data and experience request data received from a terminal device;
inputting the prompt sentence to the generative neural network model and receiving visual content data comprising at least one of image data or video data from the generative neural network model;
applying format conversion processing or quality adjustment processing to the visual content data and storing the processed visual content data in the storage device; and
receiving a user state parameter derived from interaction data of a user of the terminal device, and adjusting at least one of content selection criteria or generation conditions of the prompt sentence based on the user state parameter prior to a subsequent content generation cycle.
